(19) United States
(12) Patent Application Publication
(10) Pub. No.: US 2018/0189080 A1
(43) Pub. Date: Jul. 5, 2018

(54) System And Method For Reacquiring A Running Service After Restarting A Configurable Platform Instance

(71) Applicant: SOCIETAL INNOVATIONS IPCO LIMITED, London (GB)

(72) Inventors: Douglas A. STANDLEY, Boulder, CO (US); Matthew R. DODGE, Dana Point, CA (US); Randall E. BYE, Louisville, CO (US); Timothy F. BLISS, Louisville, CO (US)

(21) Appl. No.: 15/740,085

(22) PCT Filed: Jun. 24, 2016
(86) PCT No.: PCT/IB2016/001014

§ 371 Date: Dec. 27, 2017

Related U.S. Application Data
(60) Provisional application No. 62/186,809, filed on Jun. 30, 2015.

(51) Int. Cl. G06F 9/445; G06F 9/4401

(52) U.S. Cl. CPC G06F 9/44505; G06F 9/4418

(57) ABSTRACT

An improved system and method are disclosed for reacquiring a service on a configurable neutral input/output (NIO) platform. In one example, the method includes determining, by a core of a NIO platform instance that is running on a device, whether any services that the core is configured to start are currently running on the device before being started by the core. The core attempts to reacquire any of the services that are currently running. Reacquiring a service integrates the service with the NIO platform instance and a normal startup process is not performed for any service that has been reacquired. The core performs the normal startup process to create a new instance of any of the services that have not been reacquired and are to be started.

### CROSS-REFERENCE TO RELATED APPLICATIONS

This application is a Patent Cooperation Treaty Application of U.S. Provisional Application No. 62/186,809, filed Jun. 30, 2015, and entitled SYSTEM AND METHOD FOR REACQUIRING A RUNNING SERVICE AFTER RESTARTING A CONFIGURABLE PLATFORM INSTANCE (Atty. Dkt. No. SNVS-32699), the specification of which is incorporated by reference herein in its entirety.

### BACKGROUND

The proliferation of devices has resulted in the production of a tremendous amount of data that is continuously increasing. Current processing methods are unsuitable for processing this data. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a neutral input/output (NIO) platform with customizable and configurable processing functionality and configurable support functionality;

FIG. 1B illustrates one embodiment of a data path that may exist within a NIO platform instance based on the NIO platform of FIG. 1A;

FIGS. 1C and 1D illustrate embodiments of the NIO platform of FIG. 1A as part of a stack;

FIG. 1E illustrates one embodiment of a system on which the NIO platform of FIG. 1A may be run;

FIG. 2 illustrates a more detailed embodiment of the NIO platform of FIG. 1A;

FIG. 3A illustrates another embodiment of the NIO platform of FIG. 2;

FIG. 3B illustrates one embodiment of a NIO platform instance based on the NIO platform of FIG. 3A;

FIG. 4 illustrates one embodiment of a workflow that may be used to create and configure a NIO platform;

FIG. 5 illustrates one embodiment of the NIO platform of FIG. 4;

FIG. 6 illustrates one embodiment of a component configuration environment within which a component is configured at runtime using only predefined configuration information;

FIG. 7 illustrates one embodiment of a component configuration environment within which a component is configured at runtime using a context;

FIG. 8 illustrates one embodiment of a service that may be used within the NIO platform of FIG. 5;

FIGS. 9-11 illustrate embodiments of methods that may be executed by the NIO platform of FIG. 5 to configure components using contexts;

FIGS. 12-18 illustrate embodiments of sequence diagrams that show communications between various components of the NIO platform of FIG. 4 that may occur in order to store and/or retrieve persistence information;

FIGS. 19-23 illustrate embodiments of methods that may be executed within the NIO platform of FIG. 4 in order to store and/or retrieve persistence information;

FIG. 24 illustrates one embodiment of a diagram showing the operation of a core process and multiple services of the NIO platform instance of FIG. 4 plotted against time;

FIGS. 25A-28B illustrate embodiments of methods that may be executed within the NIO platform of FIG. 4 during startup;

FIGS. 29A-29C illustrate embodiments of sequence diagrams that show different startup processes that may be used by the NIO platform of FIG. 4;

FIGS. 30A and 30B illustrate embodiments of diagrams that show different channel configurations that may be used within the NIO platform of FIG. 4; and

FIG. 31 illustrates one embodiment of a method that may be executed by a service within the NIO platform of FIG. 4.

### DETAILED DESCRIPTION

The present disclosure is directed to a system and method for reacquiring services after a neutral input/output platform instance is restarted. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This application refers to U.S. patent application Ser. No. 14/885,629, filed on Oct. 16, 2015, and entitled SYSTEM AND METHOD FOR FULLY CONFIGURABLE REAL TIME PROCESSING, which is a continuation of PCT/IB2015/001288, filed on May 21, 2015, both of which are incorporated by reference in their entirety.

The present disclosure describes various embodiments of a neutral input/output (NIO) platform that includes a core that supports one or more services. While the platform itself may technically be viewed as an executable application in some embodiments, the core may be thought of as an application engine that runs task specific applications called services. The services are constructed using defined templates that are recognized by the core, although the templates can be customized to a certain extent. The core is designed to manage and support the services, and the services in turn manage blocks that provide processing functionality to their respective service. Due to the structure and flexibility of the runtime environment provided by the NIO platform's core, services, and blocks, the platform is able to asynchronously process any input signal from one or more sources in real time.

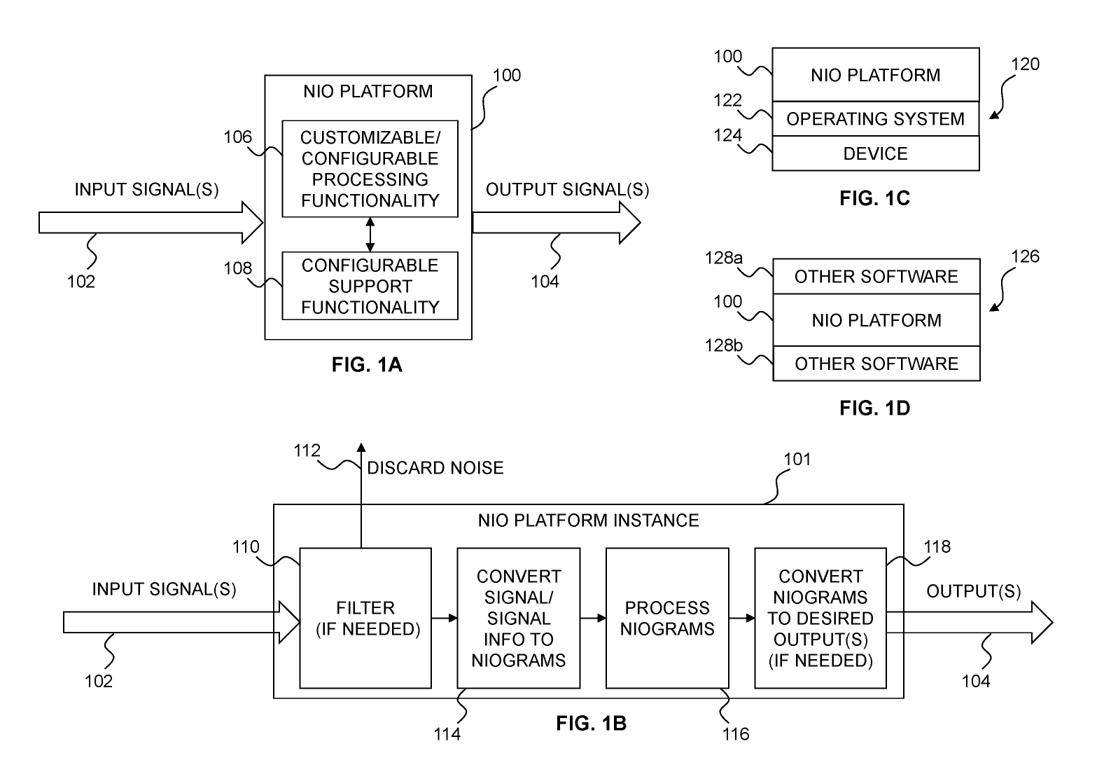

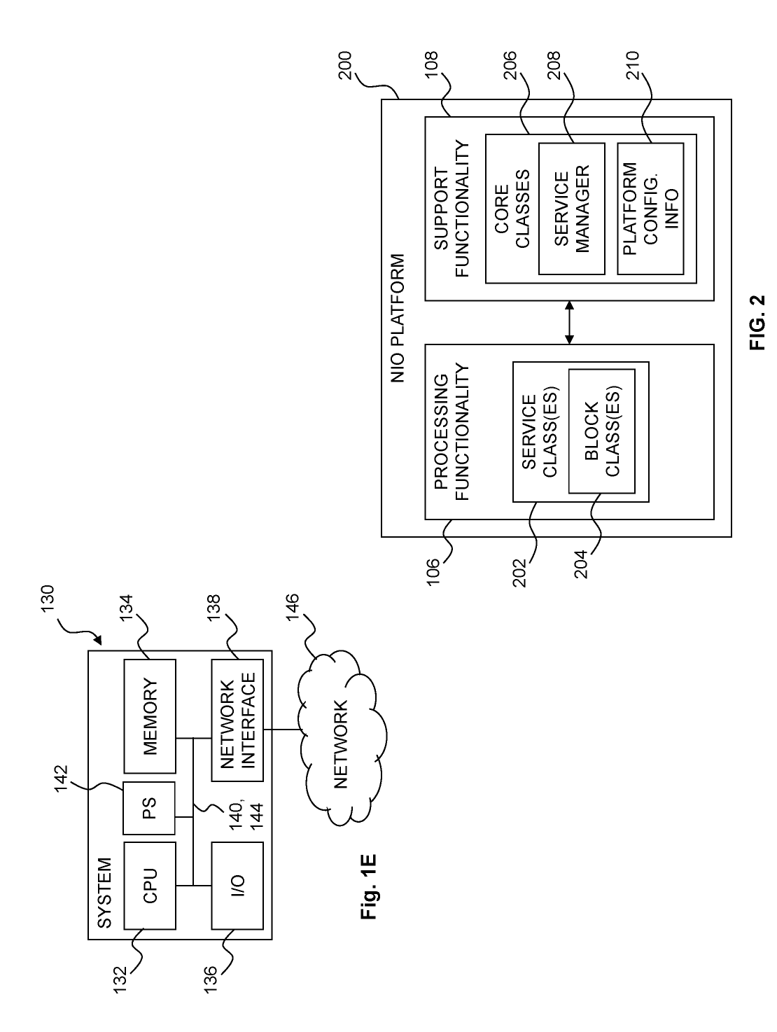

Referring to FIG. 1A, one embodiment of a NIO platform 100 is illustrated. The NIO platform 100 is configurable to receive any type of signal (including data) as input, process those signals, and produce any type of output. The NIO platform 100 is able to support this process of receiving, processing, and producing in real time or near real time. The input signals can be streaming or any other type of continuous or non-continuous input.

When referring to the NIO platform 100 as performing processing in real time and near real time, it means that there is no storage other than possible queuing between the NIO platform instance's input and output. In other words, only processing time exists between the NIO platform instance's input and output as there is no storage read and write time, even for streaming data entering the NIO platform 100.

It is noted that this means there is no way to recover an original signal that has entered the NIO platform 100 and been processed unless the original signal is part of the output or the NIO platform 100 has been configured to save the original signal. The original signal is received by the NIO platform 100, processed (which may involve changing and/or destroying the original signal), and output is generated. The receipt, processing, and generation of output occurs without any storage other than possible queuing. The original signal is not stored and deleted, it is simply never stored. The original signal generally becomes irrelevant as it is the output based on the original signal that is important, although the output may contain some or all of the original signal. The original signal may be available elsewhere (e.g., at the original signal's source), but it may not be recoverable from the NIO platform 100.

It is understood that the NIO platform 100 can be configured to store the original signal at receipt or during processing, but that is separate from the NIO platform's ability to perform real time and near real time processing. For example, although no long term (e.g., longer than any necessary buffering) memory storage is needed by the NIO platform 100 during real time and near real time processing, storage to and retrieval from memory (e.g., a hard drive, a removable memory, and/or a remote memory) is supported if required for particular applications.

The internal operation of the NIO platform 100 uses a NIO data object (referred to herein as a niogram). Incoming signals 102 are converted into niograms at the edge of the NIO platform 100 and used in intra-platform communications and processing. This allows the NIO platform 100 to handle any type of input signal without needing changes to the platform's core functionality. In embodiments where multiple NIO platforms are deployed, niograms may be used in inter-platform communications.

The use of niograms allows the core functionality of the NIO platform 100 to operate in a standardized manner regardless of the specific type of information contained in the niograms. From a general system perspective, the same core operations are executed in the same way regardless of the input data type. This means that the NIO platform 100 can be optimized for the niogram, which may itself be optimized for a particular type of input for a specific application.

The NIO platform 100 is designed to process niograms in a customizable and configurable manner using processing functionality 106 and support functionality 108. The processing functionality 106 is generally both customizable and configurable by a user. Customizable means that at least a portion of the source code providing the processing functionality 106 can be modified by a user. In other words, the task specific software instructions that determine how an input signal that has been converted into one or more niograms will be processed can be directly accessed at the code level and modified. Configurable means that the processing functionality 106 can be modified by such actions as selecting or deselecting functionality and/or defining values for configuration parameters. These modifications do not require direct access or changes to the underlying source code and may be performed at different times (e.g., before runtime or at runtime) using configuration files, commands issued through an interface, and/or in other defined ways.

The support functionality 108 is generally only configurable by a user, with modifications limited to such actions as selecting or deselecting functionality and/or defining values for configuration parameters. In other embodiments, the support functionality 108 may also be customizable. It is understood that the ability to modify the processing functionality 106 and/or the support functionality 108 may be limited or non-existent in some embodiments.

The support functionality 108 supports the processing functionality 106 by handling general configuration of the NIO platform 100 at runtime and providing management functions for starting and stopping the processing functionality. The resulting niograms can be converted into any signal type(s) for output(s) 104.

Referring to FIG. 1B, one embodiment of a NIO platform instance 101 illustrates a data path that starts when the input signal(s) 102 are received and continues through the generation of the output(s) 104. The NIO platform instance 101 is created when the NIO platform 100 of FIG. 1A is launched. A NIO platform may be referred to herein as a “NIO platform” before being launched and as a “NIO platform instance” after being launched, although the terms may be used interchangeably for the NIO platform after launch. As described above, niograms are used internally by the NIO platform instance 101 along the data path.

In the present example, the input signal(s) 102 may be filtered in block 110 to remove noise, which can include irrelevant data, undesirable characteristics in a signal (e.g., ambient noise or interference), and/or any other unwanted part of an input signal. Filtered noise may be discarded at the edge of the NIO platform instance 101 (as indicated by arrow 112) and not introduced into the more complex processing functionality of the NIO platform instance 101. The filtering may also be used to discard some of the signal's information while keeping other information from the signal. The filtering saves processing time because core functionality of the NIO platform instance 101 can be focused on relevant data having a known structure for post-filtering processing. In embodiments where the entire input signal is processed, such filtering may not occur. In addition to or as alternative to filtering occurring at the edge, filtering may occur inside the NIO platform instance 101 after the signal is converted to a niogram.

Non-discarded signals and/or the remaining signal information are converted into niograms for internal use in block 114 and the niograms are processed in block 116. The niograms may be converted into one or more other formats for the output(s) 104 in block 118, including actions (e.g., actuation signals). In embodiments where niograms are the output, the conversion step of block 118 would not occur.

Referring to FIG. 1C, one embodiment of a stack 120 is illustrated. In the present example, the NIO platform 100 interacts with an operating system (OS) 122 that in turn interacts with a device 124. The interaction may be direct or may be through one or more other layers, such as an interpreter or a virtual machine. The device 124 can be a virtual device or a physical device, and may be standalone or coupled to a network.

Referring to FIG. 1D, another embodiment of a stack 126 is illustrated. In the present example, the NIO platform 100 interacts with a higher layer of software 128 a and/or a lower layer of software 128b. In other words, the NIO platform 100 may provide part of the functionality of the stack 126, while the software layers 128a and/or 128b provide other parts of the stack's functionality. Although not shown, it is understood that the OS 122 and device 124 of FIG. 1C may be positioned under the software layer 128b if the software 128b is present or directly under the NIO platform 100 (as in FIG. 1C) if the software layer 128b is not present.

Referring to FIG. 1E, one embodiment of a system 130 is illustrated. The system 130 is one possible example of a portion or all of the device 124 of FIG. 1C. The system 130 may include a controller (e.g., a processor/central processing unit (“CPU”)) 132, a memory unit 134, an input/output (“I/O”) device 136, and a network interface 138. The components 132, 134, 136, and 138 are interconnected by a data transport system (e.g., a bus) 140. A power supply (PS) 142 may provide power to components of the system 130 via a power transport system 144 (shown with data transport system 140, although the power and data transport systems may be separate).

It is understood that the system 130 may be differently configured and that each of the listed components may actually represent several different components. For example, the CPU 132 may actually represent a multi-processor or a distributed processing system; the memory unit 134 may include different levels of cache memory, main memory, hard disks, and remote storage locations; the I/O device 136 may include monitors, keyboards, and the like; and the network interface 138 may include one or more network cards providing one or more wired and/or wireless connections to a network 146. Therefore, a wide range of flexibility is anticipated in the configuration of the system 130, which may range from a single physical platform configured primarily for a single user or autonomous operation to a distributed multi-user platform such as a cloud computing system.

The system 130 may use any operating system (or multiple operating systems), including various versions of operating systems provided by Microsoft (such as WINDOWS), Apple (such as Mac OS X), UNIX, and LINUX, and may include operating systems specifically developed for handheld devices (e.g., iOS, Android, Blackberry, and/or Windows Phone), personal computers, servers, and other computing platforms depending on the use of the system 130. The operating system, as well as other instructions (e.g., for telecommunications and/or other functions provided by the device 124), may be stored in the memory unit 134 and executed by the processor 132. For example, if the system 130 is the device 124, the memory unit 134 may include instructions for providing the NIO platform 100 and for performing some or all of the methods described herein.

The network 146 may be a single network or may represent multiple networks, including networks of different types, whether wireless or wireline. For example, the device 124 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 124 with external devices.

Referring to FIG. 2, a NIO platform 200 illustrates a more detailed embodiment of the NIO platform 100 of FIG. 1A. In the present example, the NIO platform 200 includes two main components: service classes 202 for one or more services that are to provide the configurable processing functionality 106 and core classes 206 for a core that is to provide the support functionality 108 for the services. Each service corresponds to block classes 204 for one or more blocks that contain defined task specific functionality for processing niograms. The core includes a service manager 208 that will manage the services (e.g., starting and stopping a service) and platform configuration information 210 that defines how the NIO platform 200 is to be configured, such as what services are available when the instance is launched.

When the NIO platform 200 is launched, a core and the corresponding services form a single instance of the NIO platform 200. It is understood that multiple concurrent instances of the NIO platform 200 can run on a single device (e.g., the device 124 of FIG. 1C). Each NIO platform instance has its own core and services. The most basic NIO platform instance is a core with no services. The functionality provided by the core would exist, but there would be no services on which the functionality could operate. Because the processing functionality of a NIO platform instance is defined by the executable code present in the blocks and the services are configured as collections of one or more blocks, a single service containing a single block is the minimum configuration required for any processing of a niogram to occur.

It is understood that FIG. 2 illustrates the relationship between the various classes and other components. For example, the block classes are not actually part of the service classes, but the blocks are related to the services. Furthermore, while the service manager 208 is considered to be part of the core for purposes of this example (and so created using the core classes), the core configuration information is not part of the core classes but is used to configure the core and other parts of the NIO platform 200.

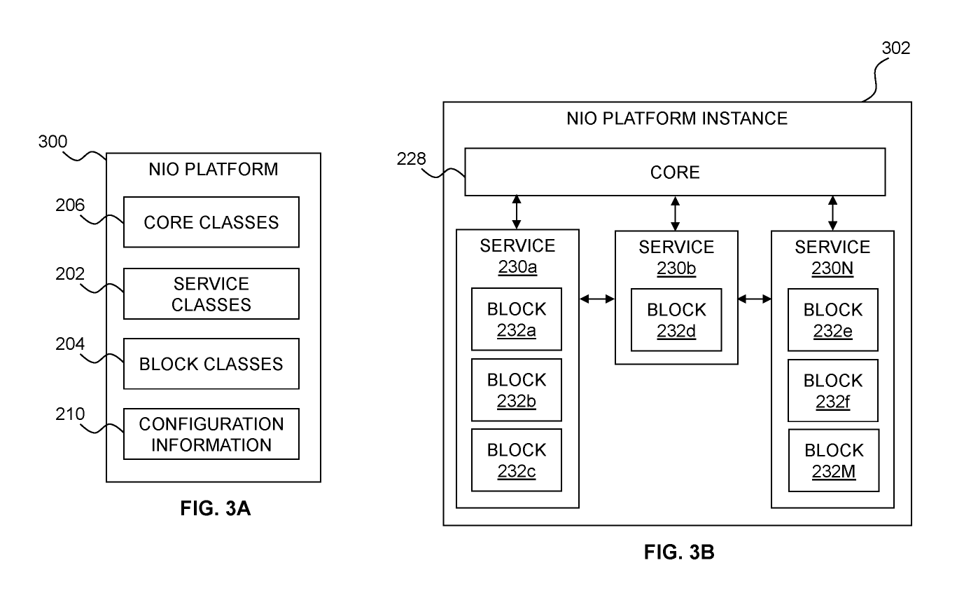

With additional reference to FIGS. 3A and 3B, another embodiment of the NIO platform 200 of FIG. 2 is illustrated as a NIO platform 300 prior to being launched (FIG. 3A) and as a NIO platform instance 302 after being launched (FIG. 3B). FIG. 3A illustrates the NIO platform 300 with core classes 206, service classes 202, block classes 204, and configuration information 210 that are used to create and configure a core 228, services 230a-230N, and blocks 232a-232M of the NIO platform instance 302. It is understood that, although not shown in FIG. 3B, the core classes 206, service classes 202, block classes 204, and configuration information 210 generally continue to exist as part of the NIO platform instance 402.

Referring specifically to FIG. 3B, the NIO platform instance 302 may be viewed as a runtime environment within which the core 228 creates and runs the services 230a, 230b, . . . , and 230N. Each service 230a-230N may have a different number of blocks. For example, service 230a includes blocks 232a, 232b, and 232c. Service 230b includes a single block 232d. Service 230N includes blocks 232e, 232f, . . . , and 232M.

One or more of the services 230a-230N may be stopped or started by the core 228. When stopped, the functionality provided by that service will not be available until the service is started by the core 228. Communication may occur between the core 228 and the services 230a-230N, as well as between the services 230a-230N themselves.

In the present example, the core 228 and each service 230a-230N is a separate process from an operating system/hardware perspective. Accordingly, the NIO platform instance 302 of FIG. 3B would have N+1 processes running, and the operating system may distribute those across multi-core devices as with any other processes. It is understood that the configuration of particular services may depend in part on a design decision that takes into account the number of processes that will be created. For example, it may be desirable from a process standpoint to have numerous but smaller services in some embodiments, while it may be desirable to have fewer but larger services in other embodiments. The configurability of the NIO platform 300 enables such decisions to be implemented relatively easily by modifying the functionality of each service 230a-230N.

In other embodiments, the NIO platform instance 302 may be structured to run the core 228 and/or services 230a-230N as threads rather than processes. For example, the core 228 may be a process and the services 230a-230N may run as threads of the core process.

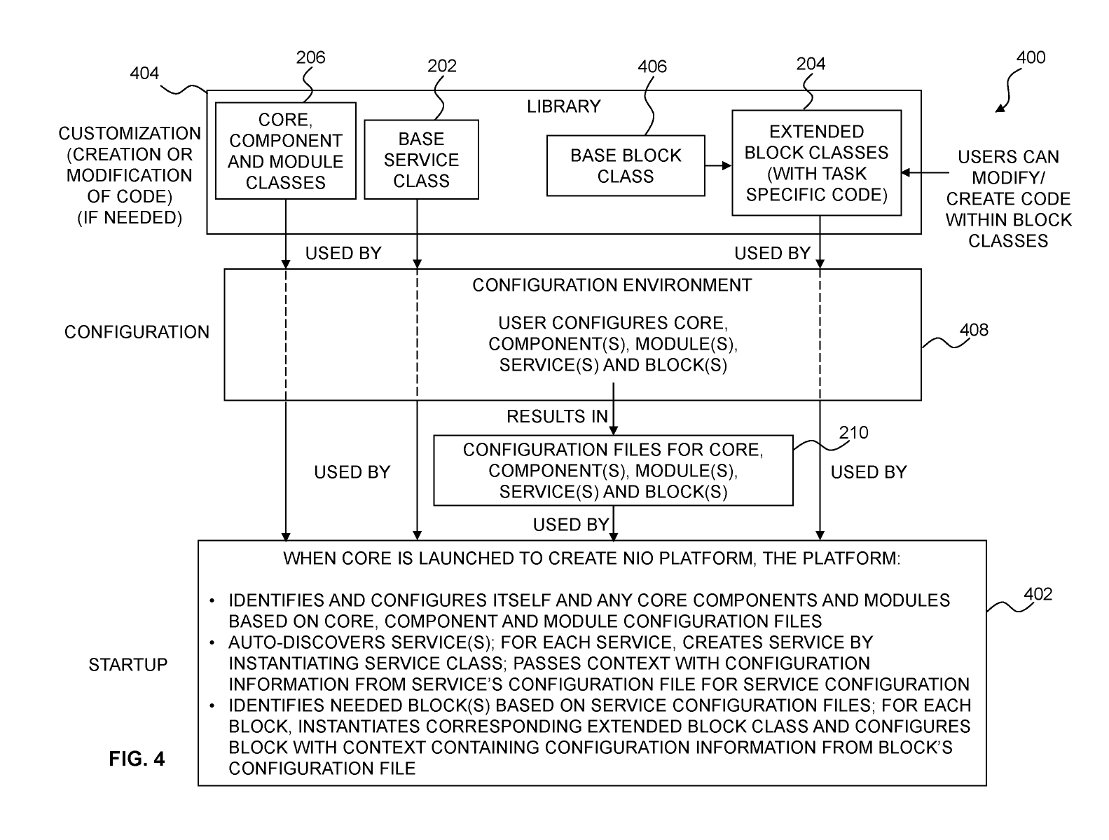

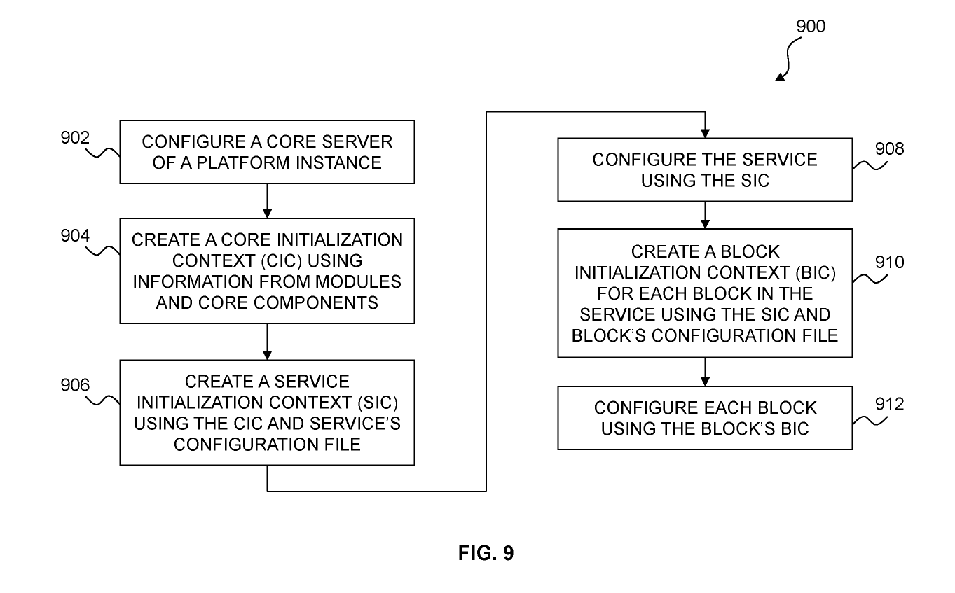

Referring to FIG. 4, a diagram 400 illustrates one embodiment of a workflow that runs from creation to launch of a NIO platform 402 (which may be similar or identical to the NIO platform 100 of FIG. 1A, 200 of FIG. 2, and/or 300 of FIG. 3 (and/or 900 of FIGS. 9A and 9B of previously referenced U.S. patent application Ser. No. 14/885,629). The workflow begins with a library 404. The library 404 includes core classes 206 (that include the classes for any core components and modules in the present example), a base service class 202, a base block class 406, and block classes 204 that are extended from the base block class 406. Each extended block class 204 includes task specific code. A user can modify and/or create code for existing blocks classes 204 in the library 404 and/or create new block classes 204 with desired task specific functionality. Although not shown, the base service class 202 can also be customized and various extended service classes may exist in the library 404.

The configuration environment 408 enables a user to define configurations for the core classes 206, the service class 202, and the block classes 204 that have been selected from the library 404 in order to define the platform specific behavior of the objects that will be instantiated from the classes within the NIO platform 402. The NIO platform 402 will run the objects as defined by the architecture of the platform itself, but the configuration process enables the user to define various task specific operational aspects of the NIO platform 402. The operational aspects include which core components, modules, services and blocks will be run, what properties the core components, modules, services and blocks will have (as permitted by the architecture), and when the services will be run. This configuration process results in configuration files 210 that are used to configure the objects that will be instantiated from the core classes 206, the service class 202, and the block classes 204 by the NIO platform 402.

In some embodiments, the configuration environment 408 may be a graphical user interface environment that produces configuration files that are loaded into the NIO platform 402. In other embodiments, the configuration environment 408 may use a REST interface (e.g., the REST interface 908, 964 described in the previously referenced U.S. patent application Ser. No. 14/885,629) of the NIO platform 402 to issue configuration commands to the NIO platform 402. Accordingly, it is understood that there are various ways in which configuration information may be created and produced for use by the NIO platform 402.

When the NIO platform 402 is launched, each of the core classes 206 are identified and corresponding objects are instantiated and configured using the appropriate configuration files 210 for the core, core components, and modules. For each service that is to be run when the NIO platform 402 is started, the service class 202 and corresponding block classes 204 are identified and the services and blocks are instantiated and configured using the appropriate configuration files 210. The NIO platform 402 is then configured and begins running to perform the task specific functions provided by the services.

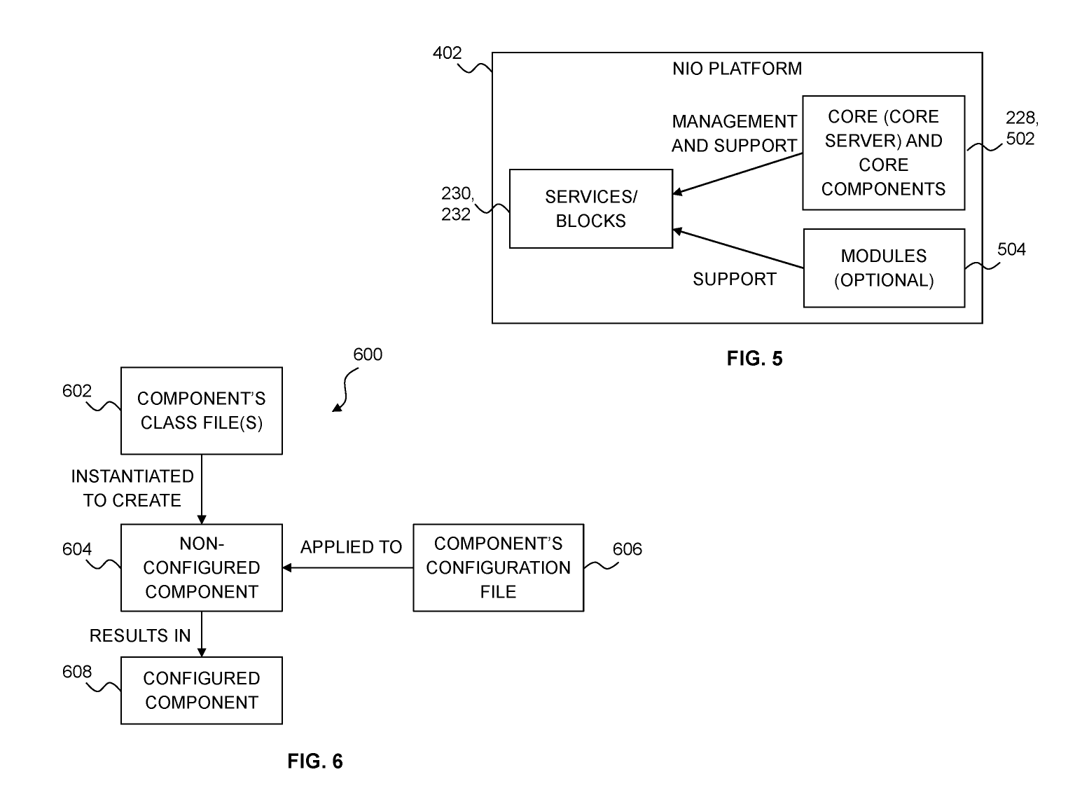

Referring to FIG. 5, one embodiment of the NIO platform 402 is illustrated and described with respect to a startup process. The NIO platform's structure is extremely flexible and can be configured to perform many different tasks in many different environments. Therefore, the startup process that is used when a NIO platform is launched should be robust and able to properly configure any NIO platform regardless of the platform's particular configuration. Configuration variations can include different services 230 and service configurations, different blocks 232 and block configurations, the presence/absence of optional core components 502 (e.g., the core components 912 described in the previously referenced U.S. patent application Ser. No. 14/885,629) and their configurations, different implementations and configurations of modules 504 (e.g., the modules 904 described in the previously referenced U.S. patent application Ser. No. 14/885,629), and different locations for resources.

Furthermore, some configuration information is not available until the startup process is underway. This means that the startup process should accommodate not only predefined configuration information, but also information that is unknown until various points in the startup process are reached.

Accordingly, the startup process in the present example uses both predefined configuration files and dynamically generated objects called contexts that incorporate information not known before startup. This allows configuration information 210 (FIG. 2A) to make its way from a file on disk, through the core 228, and ultimately to the blocks 232 in a new process, while also incorporating dynamically generated information. When finished, the startup process will have properly initialized the NIO platform's components and created a running NIO platform 402 that can perform the tasks it is configured to perform.

As illustrated in FIG. 5, the architecture of the NIO platform 402 can be divided into two main parts: (1) the management and support functionality provided by a core server 228 that forms the base of the NIO platform 402, the core components 502, and optional modules 504, and (2) the task specific functionality provided by the service components (services 230 and blocks 232). The core server 228, core components 502, modules 504, services 230, and blocks 232 are generally all initialized when the NIO platform 402 is launched, although some components (e.g., services 230 and blocks 232) may not be initialized until needed. For convenience, the core server 228, core components 502, modules 504, services 230, and blocks 232 are all generally referred to as “components” in the present embodiment and in some later embodiments. When a particular component is being described, its name will be used (i.e., core server 228, core component 502, module 504, service 230, or block 232).

Each component is initialized by instantiating the component using one or more class files and then configuring the instantiated component. There are two different ways that configuration can occur within the NIO platform 402: (1) using only a configuration file or (2) using a context. The configuration type (i.e., configuration file or context) used with each component is illustrated below in Table 1 along with the part of the NIO platform 402 that is responsible for providing the configuration to the component.

TABLE 1

| | Configuration type | Configuration |
|---|---|---|
| | (i.e., configuration | information |
| Component | file or context) | provided by |
| Core 228 | Core's configuration file | N/A (predefined) |
| (core server) | | |
| Modules | Configuration file | N/A (predefined) |
| 504 | (unique for each module) | |
| Core | Core Initialization | Core Server (CIC |
| components | Context (CIC) | is modifiable by |
| 502 | | Core components) |
| Services | Service Initialization | Service Manager |
| 230 | Context (SIC) | |
| | (unique for each service) | |
| Block | Block Router Initialization | Service process |
| routers | Context (BRIC) (unique for | |
| | each block router) | |
| Blocks | Block Initialization | Service process |
| 232 | Context (BIC) | |
| | (unique for each block) | |

In Table 1, it is noted that the core server 228 and block routers (e.g., the block router 921 described in the previously referenced U.S. patent application Ser. No. 14/885,629) may not technically be considered components. The core server 228 is the foundation of the entire NIO platform 402 and a block router is considered to be part of the corresponding service 230 rather than a standalone component. However, the core server 228 and block routers are described as components for purposes of this example because they are both instantiated from their own class files and configured using a configuration file (for the core server 228) or a context (for the block router) in the same manner as other components.

Although the each SIC, BRIC, and BIC are described as being unique to their respective service 230, block router, and block 232, it is understood that they may be combined in other embodiments. For example, a single SIC may be used for all services 230, with each service 230 extracting the needed configuration information corresponding to itself from the SIC. Similarly, a single BIC may be used for all blocks 232 in a service 230 or all blocks 232 in the NIO platform 402, with each block 232 extracting the needed configuration information corresponding to itself from the BIC. Accordingly, while individual SICs, BRICs, and BICs are used in the present embodiment, other implementations may be used.

Referring to FIG. 6, one embodiment of a configuration environment 600 within which the core server 228 and modules 504 are configured using only predefined configuration information is illustrated. When the core server 228 and modules 504 are initialized, the component's class file(s) 602 are instantiated to create a non-configured object 604. Configuration information from the component's configuration file 606 is then applied to the non-configured component to form a configured component 608. The configuration information is unique to the component being configured.

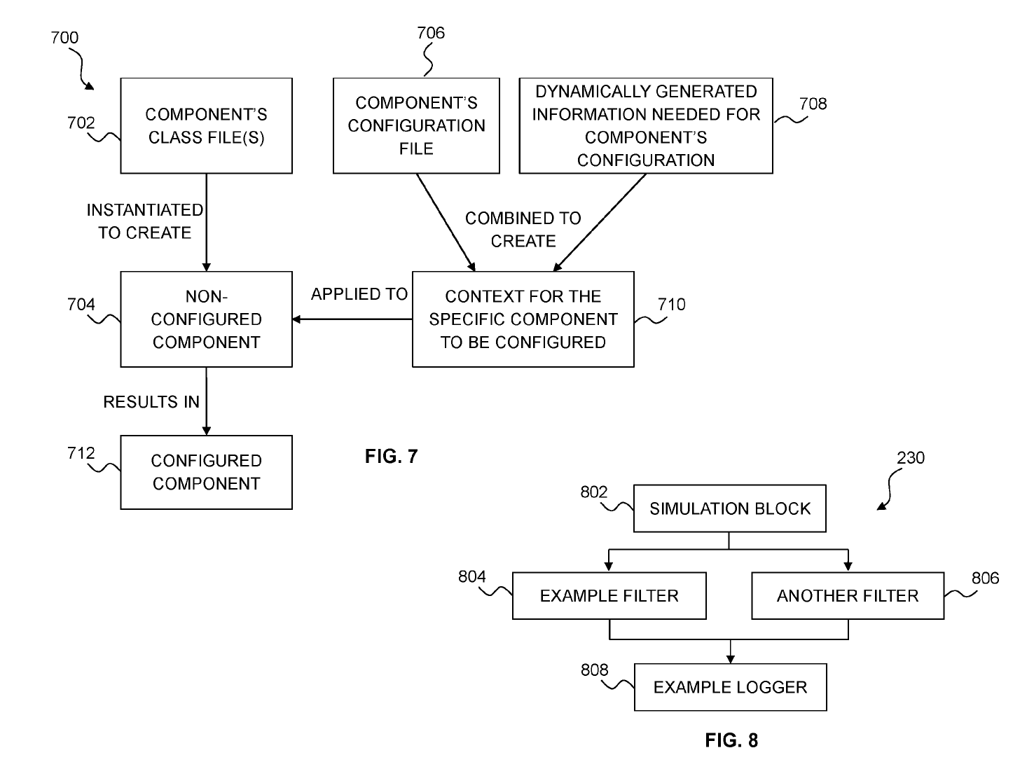

Referring to FIG. 7, one embodiment of a configuration environment 700 within which the core components 502, services 230, block routers, and blocks 232 are configured using a context is illustrated. When the core components 502, services 230, block routers, and blocks 232 are initialized, the component's class file(s) 702 are instantiated to create a non-configured object 704. Configuration information from the component's configuration file 706 is then combined with dynamically generated configuration information 708 to create a context 710 for the specific component being configured. Accordingly, the context is built from two types of information: (1) the configuration file 706 that contains predefined information for that component known before startup, and (2) the dynamically generated information 708 that is known only after startup. The context 710 then applied to the non-configured component 704 to form a configured component 712.

Referring again to FIG. 5, in the present embodiment of the startup process for the NIO platform 402, the context needed for the core components 502, services 230, block routers, and blocks 232 must be built before those components can be started. Therefore, the NIO platform 402 follows a particular order of operations during startup. This order of operations prioritizes the startup order of the core server 228, modules 504, core components 502, services 230, block routers, and blocks 232 so that components that contribute information to the contexts used by other components are started first.

The startup process of the NIO platform 402 can be separated between the two parts of the NIO platform illustrated in FIG. 5, with the management and support components being started before the service components. The basic order of startup steps for one embodiment of the NIO platform 402 is shown below in Table 2.

TABLE 2

| | | | Component(s) |
|---|---|---|---|
| Startup | Component | Component(s) involved | involved in |
| step | being started | in initialization | configuration |
| 1 | Core (core | Self (core server process) | Self |
| | server) 228 | | |
| 2 | Modules 504 | Core server | Self |
| 3 | Core | Core server | Self |
| | components | | |
| | 502 | | |
| 4 | Services 230 | Service Manager, | Self |
| | | Block Manager | |
| 5 | Block router | Service process corresponding | Self |
| | | to block router | |
| 6 | Blocks 232 | Service process corresponding | Self |
| | | to block | |

In the present embodiment, it is understood that steps 4-6 of Table 2 occur on a per service basis. For example, step 6 may be executed to initialize the block router for a service #1 at the same time that step 5 is being repeatedly executed to initialize the blocks 232 for a service #2 and step 4 is being executed to initialize the base service process 230 for a service #3. Furthermore, while Table 2 shows that the block router is started before the blocks 232, the block router is created before the blocks 232 are initialized, but is not configured until after the blocks 232 are initialized.

The initialization processes for the core server 228, core components 502, and modules 504 are interleaved. The core process controls the timing. This is illustrated below in outline form:
1. Core process launched
2. Core configuration information parsed
3. Environment settings and variables created
4. Core server created
5. Core server run
   a. Core server configured
      i. Modules discovered
      ii. Modules initialized
      iii. Component manager created
      iv. Core components discovered
         1. Each core component initialized and saved in component manager
      v. CIC created—contains references to components and modules
      vi. CIC passed to each module
      vii. Component manager configured with CIC
         1. Each core component configured with CIC
   b. Core server started
      i. Component manager started
         1. Each core component started

In the present embodiment, the service manager 208 (e.g., the service manager 914 described in the previously referenced U.S. patent application Ser. No. 14/885,629), which is a required core component 502, is responsible for starting any services 230 that can be auto-started. This happens in the start method for the service manager 208, so starting services 230 occurs at 5(b)(i)(1), and starting blocks 232 also occurs at that point because the blocks 232 are considered to be part of their respective service 230 from a startup perspective. The following examples describing the initialization of the core server 228, core components 502, and modules 504 should be read in conjunction with the interleaving illustrated in the outline.

When the core process is launched to start the core server 228, the core process accesses a core configuration file to determine the core server's configuration. An example of a core configuration file is shown below:

[DEFAULT]
[provider]
conf: etc
type: nio.configuration.providers.file.FileConfigurationProvider
[modules]
# location of the module configuration files
conf: etc/modules
load: logging, persistence, scheduler, security, threading, web,
communication
[service]
# location of overall service configuration
conf: etc/service.cfg
block_router:
nio.common.block.router.thread_pool_executor.-
ThreadedPoolExecutorRouter
[environment]
# location of custom extensions (blocks, services, etc)
blocks.path: blocks
[ipc]
request_time_to_live: 5.0
[server]
# settings for the web server that will host the core REST API
host: [[NIOHOST]]
port: [[NIOPORT]]

Based on the core configuration file, the core process is able to load needed components and identify the location of needed resources. Once the core server 228 is started and configured, the core 228 creates a Core Initialization Context (CIC).

The CIC may include information on core components 502, configuration information for modules 504, and a shutdown method that can be called to safely shut down the NIO platform 402. The CIC's information on core components 502 may include a list of core components installed in the node (i.e., the REST API, service manager 208, component manager (which may be considered to be part of the core server 228, rather than a standalone component), a block manager, a configuration manager (e.g., the configuration manager 910 described in the previously referenced U.S. patent application Ser. No. 14/885,629), and any other components, such as components for messaging 958 and monitoring 956 described in the previously referenced U.S. patent application Ser. No. 14/885,629. The configuration information for modules 504 may include a configuration dictionary for each module, specified by a file such as a .cfg file.

The core server 228 registers all of the modules 504 in the CIC, and then passes the CIC to the component manager. The component manager passes the CIC to each core component 502 and allows the core components 502 to read from and alter the CIC so that later components (e.g., services 230 and blocks 232) can access the core components 502 if needed.

The core server 228 starts the modules 504. For each module 504, the core server 228 initializes the module 504 and the module 504 configures itself (if needed) using its own configuration file. The core server 228 registers each module 504 and module specific information in the CIC so that other components will have the information needed to use the modules 504.

After the modules 504 are started and registered in the CIC, the core server 228 starts the component manager. The component manager detects and loads each core component 502, and also passes the CIC to each core component 502. The core components 502 can add their own information to the CIC for use by other components.

Services 230 are started on a per service basis. Each service configuration file has an “auto-start” field. If the field is set to “true,” the core server 228 will automatically start the service 230 during the NIO platform's startup process. If the field is set to “false,” the core server 228 will only start the service 230 after receiving a “start” command instructing it to start the service 230. The same startup process is used regardless of when a service 230 is started.

Services 230 can also be stopped on a per service basis. After being stopped, a service 230 must be restarted to be used. In the present embodiment, the restart process is the same as the original startup process for a service 230. Because the same process is used any time a service 230 is started, all of the contexts for a particular service 230 will be created each time the service 230 is started. This means that previously created contexts are not reused when a service 230 is restarted. In other embodiments, portions or all of the previously used contexts may be reused.

The service manager 208 of the core server 228 uses the CIC to determine which services 230 and modules 504 are loaded into the NIO platform 402 and is responsible for launching the service processes. The service manager 208 creates a Service Initialization Context (SIC) for a service 230 immediately before that service 230 is launched. The SIC is created from the service's unique configuration file and other information that is dynamically generated during startup.

With additional reference to FIG. 8, one embodiment of a service 230 called “MyService” is illustrated. The service 230 has a block configuration with a block 802 named “SimulationBlock,” a block 804 named “ExampleFilter,” a block 806 named “AnotherFilter,” and a block 808 named “ExampleLogger.” The block 802 feeds into the two blocks 804 and 806, which in turn both feed into the block 808. An example of a configuration file for the service “MyService” is shown below:

```
{
  “auto_start”: false,
  “execution”: [
    {
      “name”: “SimulationBlock”,
      “receivers”: [
        “ExampleFilter”,
        “AnotherFilter”
      ]
    },
    {
      “name”: “ExampleFilter”,
      “receivers”: [
        “ExampleLogger”
      ]
    },
    {
      “name”: “ExampleLogger”,
              “receivers”: [ ]
    },
    {
      “name”: “AnotherFilter”,
      “receivers”: [
        “ExampleLogger”
      ]
    }
  ],
  “log_level”: “ERROR”,
  “mappings”: [ ],
  “block_router”:
  “name”: “MyService”,
  “status”: “stopped”,
  “type”: “Service”
}
```

The configuration file identifies which blocks 232 are to receive a block's output, which block router is to be used by the service 230 (e.g., the default block router in this case), the name of the service 230, and the status of the service 230.

In the present example, the SIC is the only object sent to the new service process when it is spawned and so needs to contain all the information that the service 230 needs to know from the core server 228. The SIC may include information on a service type, service properties, a service pipe, a core pipe, blocks, module configuration, modules, root, block component data, block specific component data, and service component data. The service type information refers to the base class of the service 230 to be created (e.g., service.base). The service properties information refers to properties with which to configure the service 230. The service pipe information refers to an IPC pipe used to listen to data from the core server 228. The core pipe information refers to an IPC pipe used to send data to the core server 228. The blocks information refers to a list of objects containing block classes and block properties for the service 230.

The module configuration information refers to service specific module configuration information. The modules information refers to a list of modules to initialize, which is needed when the service process is a separate process from the core process and so will have its own module instances. The root information refers to the string path of the root project environment. The block component data information refers to data that the core components 502 can pass to all blocks 232. The block specific component data information refers to data that the core components 502 can pass to specific blocks 232. The service component data information refers to data that the core components 502 can pass to services 230.

It is understood that not every service 230 may need every module 504. For example, a service 230 that only simulates and logs data (e.g., the service 230 of FIG. 8) will likely have no need for a communication module (e.g., the communication module 944 described in the previously referenced U.S. patent application Ser. No. 14/885,629). Accordingly, in some embodiments, the core 228 is able to detect this dependency and can withhold the communication module from the list of modules 504 passed to the service 230 in the SIC.

However, if a management core component is installed, it may listen to management signals and attempt to publish them along a channel. Since the service 230 is in its own process, this listener would also exist in the service process so it would require communication to be configured in that process. Therefore, the management core component can amend the modules list in the SIC to include the communication module, regardless of whether or not the blocks 232 in the service 230 need the communication module.

Block initialization relies on a Block Initialization Context (BIC) created by the service process corresponding to the block 232 being initialized. One BIC is created for each block 232 in the service 230 and is passed to the respective block 232 after the service 230 is configured. The purpose of the BIC is to let the block 232 know pertinent information. The BIC is created from the block's unique configuration file and other information that is dynamically generated during startup. An example of a configuration file for the block “SimulationBlock” of FIG. 8 is shown below:

```
{
  “attributes”: [
    {
      “name”: “”,
      “value”: {
        “end”: −1,
        “start”: 0,
        “step”: 1
      }
    }
  ],
  “interval”: {
    “days”: 0,
    “microseconds”: 0,
    “seconds”: 1
  },
  “log_level”: “ERROR”,
  “name”: “SimulationBlock”,
  “signal_count”: 1,
  “signal_type”: “nio.common.signal.base.Signal”,
  “type”: “Simulator”
}
```

The BIC may include information on a block router, block properties, component data, hooks, a service name, a command URL, and a management signal handler. The block router information refers to an instance of the block router that the service 230 will use. The block properties information refers to a dictionary of configured properties for the given block 230. The component data information refers to any data that the core components 502 wish to pass to the block 232. The hooks information refers to system-wide hooks that are available for the block 232 to subscribe to. The service name information refers to the name of the service 230 (e.g., MyService) containing the block 232. The command URL information refers to an accessible URL for the block 232 that enables the block 232 to let external sources know where the block 232 is located. The management signal handler information refers to a method that can be used by the block 232 to notify management signals.

In the present example, neither the block's configuration file nor the BIC has any information about the other blocks 232 in the service 230. Instead, the SIC (via the service configuration file) contains the list of which blocks 232 send output to which other blocks 232.

When the block class gets configured, it takes the block properties that were passed and cross references its class metadata properties. It then sets the properties so that instances of the block 232 can use the properties with which it was configured.

In addition to the general initialization process, a block 232 can be made to perform actions based on start/stop/configure events by overriding methods that are hooked to these events. For example, a user can make a block 232 perform an action when the block 232 is configured by creating an “on_configure” method in the block 232. There are some limitations on actions performed during a specific event.

On creation, a block 232 can be instructed to initialize any variables. This can be used to set the variables to a default value.

On configure, the block 232 can be instructed to prepare for handling signals. After a block 232 is configured, it should be assumed that the block 232 can process signals from another block 232. This means that a block 232 that is to log signals to a database should create its database connection in the configure call. No blocks 232 should notify signals or do anything that will cause notification of signals in the configure method.

On start, the block 232 can be instructed to perform any actions that could result in notifying signals. For a simulator, this means starting the simulator job that will notify signals here. A block 232 should not send/notify any signals until it is started. Note that no block 232 will be started until all blocks 232 are configured. This is important because once a block 232 is started, it should be assumed that the block 232 will notify signals and a block 232 must be configured to handle signals.

The initialization processes for the block router and blocks 232 are interleaved. The block router is instantiated before the blocks 232 are initialized, but is not configured until after the blocks 232 are initialized. This is because the blocks 232 need to know information about the block router when the blocks 232 are initialized, and the block router initialization relies on a Block Router Initialization Context (BRIC) that is created by the service process for the main service 230 using information from the blocks 232.

Accordingly, after all of the blocks 232 for the service 230 have been created and configured with their respective BICs, the BRIC is created and the instances of those blocks 232 are passed to it. The BRIC gets passed to the block router of the service 230 so that the block router knows how to route signals between the blocks 232. Without receiving this information from the service 230, the block router will not know where to pass signals when a particular block 232 in the service 230 notifies the service that it has output.

Information contained within the BRIC includes execution and blocks. The execution information refers to a list of block execution routings (e.g., similar to what is in the service's .cfg file). The blocks information refers to a dictionary mapping of block names to instances of blocks.

Referring to FIG. 9, a method 900 illustrates one embodiment of a process that may be executed by the NIO platform of FIG. 5 to create and configure various components during startup. In step 902, a core server 228 of the NIO platform 402 is configured. In step 904, a CIC is created using information from modules 504 and core components 502. In step 906, an SIC is created for a service 230 using information from the CIC and the service's configuration information. In step 908, the service 230 is configured using the SIC. In step 910, a BIC is created for each block 232 in the service 230 using the SIC and the block's configuration information. In step 502, each block 232 is configured using its respective BIC.

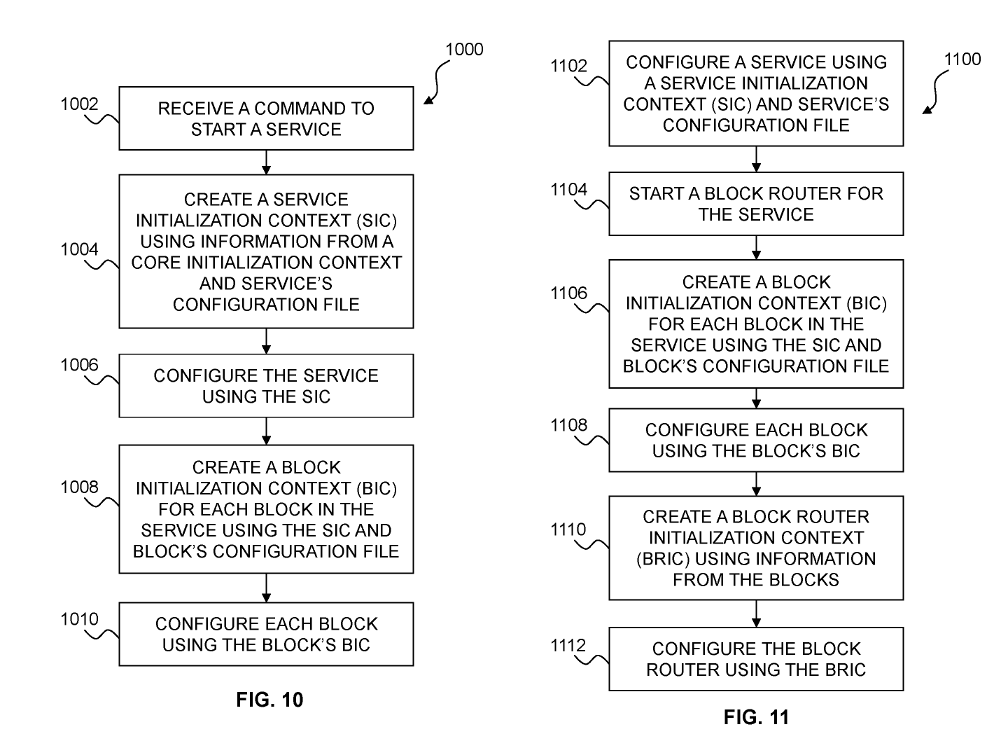

Referring to FIG. 10, a method 1000 illustrates one embodiment of a process that may be executed by the NIO platform of FIG. 5 to create and configure various components. In step 1002, a core server 228 of the NIO platform 402 receives a command to start a service 230. In step 1004, an SIC is created for the service 230 using information from a CIC and the service's configuration information. In step 1006, the service 230 is configured using the SIC. In step 1008, a BIC is created for each block 232 in the service 230 using the SIC and the block's configuration information. In step 1010, each block 232 is configured using its respective BIC.

Referring to FIG. 11, a method 1100 illustrates one embodiment of a process that may be executed by the NIO platform of FIG. 5 to create and configure various components. In step 1102, a service 230 is configured using an SIC and the service's configuration information. In step 1104, a block router is started for the service 230. In step 1106, a BIC is created for each block 232 in the service 230 using the SIC and the block's configuration information. In step 1108, each block 232 is configured using its respective BIC. In step 1110, a BRIC is created using information from the blocks 232. In step 1112, the block router is configured using the BRIC.

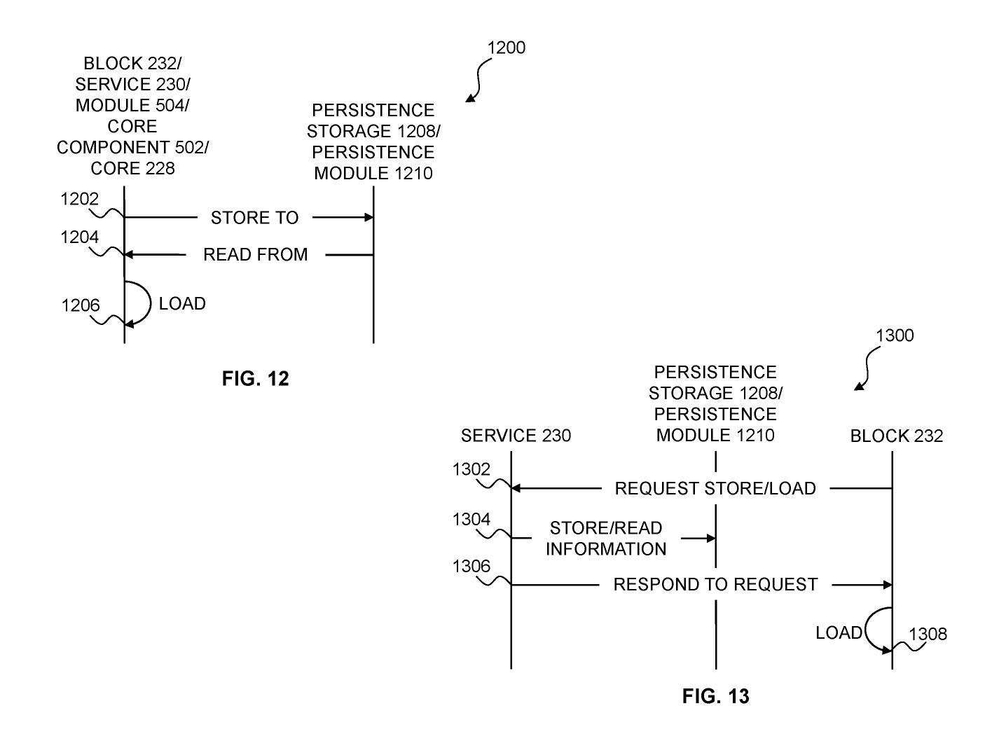

Referring to FIG. 12, a sequence diagram 1200 illustrates one embodiment of a process that may be used to provide information persistence within a NIO platform (e.g., the NIO platform 402 of FIG. 4). As previously described, the NIO platform 402 generally does not store state information or data that is being processed unless instructed to do so. However, for certain applications for which the NIO platform 402 may be used, it can be desirable to save information that can be loaded at a later time. The saving and loading of persistence information enables, for example, a service 230 to be restarted and resume running with blocks 232 that use previously saved states, rather than starting each block with a default state.

Accordingly, in step 1202, persistence information is saved by the core 228, a core component 502, a module 504, a service 230, and/or a block 232. For purposes of clarity, only the block 232 will be discussed hereafter, but it is understood that the other components of the NIO platform 402 may also save persistence information. The act of saving the persistence information can be triggered in various ways, such as by the receipt of a save command, the receipt of a stop command (e.g., save a block state when a service and its blocks are stopped), the expiration of a timer (e.g., save every thirty or sixty seconds), when a particular value is detected by a filter, before and/or after an input is received and/or an output is produced, when an error is detected, and/or upon the occurrence of any other defined event.

The persistence information can be any type of information and may include data that is being processed. For example, persistence information may include values associated with particular variables of a block. From the perspective of the storing block 232, the persistence information may be stored directly to a persistence storage 1208 or may be stored via an intermediary, such as a persistence module 1210 (e.g., the persistence module 948 described in the previously referenced U.S. patent application Ser. No. 14/885,629). The persistence storage 1208 can be any type of storage and may store information in one or more files. The persistence module 1210 may handle the saving and retrieving of information in many different ways depending on its configuration and the format of the persistence storage 1208. For example, the persistence module 1210 may use a unique file for each block 232 or may use a single file for multiple blocks 232.

In step 1204, the saved persistence information may be retrieved. Depending on the particular configuration, the retrieval may be directly from the persistence storage 1208 or may use the persistence module 1210. The act of retrieval can be triggered in various ways, such as by the receipt of a load command, when the block 232 is started (e.g., retrieve any persistence information when started), the expiration of a timer, when a particular value is detected by a filter, before and/or after an input is received and/or an output is produced, when an error is detected, and/or upon the occurrence of any other defined event.

In step 1206, the retrieved persistence information can then be loaded. For example, the persistence information can loaded as values for the appropriate variables of the block 232. The loading may occur while the NIO platform 402 is running (e.g., save and load as part of the operation of the block 232) and/or after the core 228, a core component 502, a module 504, a service 230, or a block 232 has been restarted. For example, after the block 232 is restarted, it may recover and load state information and/or other information for continued operation from a previous state. It is understood that the retrieving of step 1204 and the loading of step 1206 may be performed in a single command that assigns values that are retrieved as part of the command's argument.

It is noted that references to the storage of persistence information in the present example are generally referring to state information, and not to the storage of all information that passes through a block 232. For example, if a block 232 is to store all incoming data in a database, the persistence module 1210 would generally not be used for this storage process. Instead, a block 232 specifically designed for database inserts may be used by the service 230 as a more desirable mechanism to achieve such database storage. However, as the persistence module 1210 can be used to insert data into a database and the information to be saved by a particular block 232 can be configured as desired, the persistence module 1210 can be used for inserting some or all data that is received, processed, and/or output by the block 232 into a database or other storage.

Referring to FIG. 13, a sequence diagram 1300 illustrates another embodiment of a process that may be used to provide information persistence within a NIO platform (e.g., the NIO platform 402 of FIG. 4). In the present example, the persistence storage 1208/persistence module 1210 is used by a block 232 indirectly through a service 230 that is running the block. For example, the block 232 may make a call to save information to persistence storage. The call may be caught and handled by the service 230 in the same basic manner that the service 230 catches calls to process output from the block 232 using notifySignals( ) Alternatively, the block 232 may make a call to the persistence module 1210, and the service 230 may catch and handle the call.

Accordingly, in step 1302, the block 232 requests that information be stored or loaded. In step 1304, the service 230 handles the request and either saves the information to the persistent storage 1208 (directly or via the persistence module 1210) or retrieves information from the persistent storage 1208 (directly or via the persistence module 1210). In step 1306, the service 230 responds to the request and returns the information to the block 232 if the request was for loading information or, if a save request was received, the service may acknowledge the request and/or inform the block 232 that the information has been saved. In step 1308, if the block 232 retrieved information, the block 232 loads the information for use.

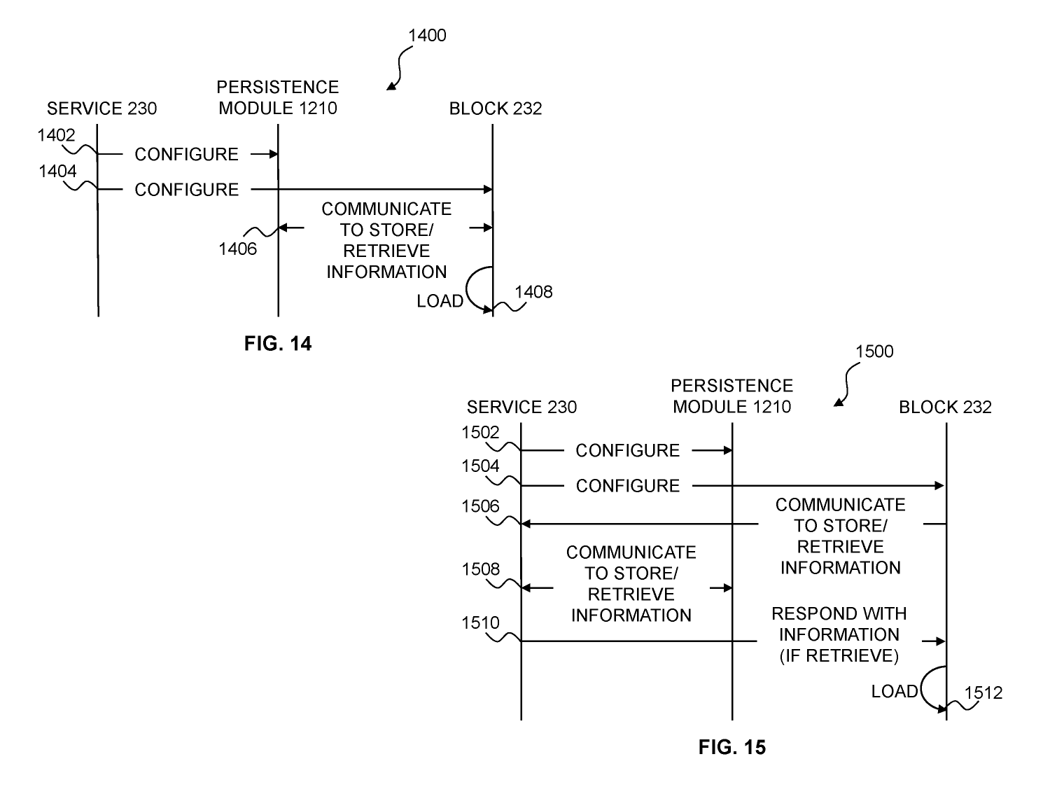

Referring to FIG. 14, a sequence diagram 1400 illustrates another embodiment of a process that may be used to provide information persistence within a NIO platform (e.g., the NIO platform 402 of FIG. 4). In the present example, the previously described persistence module 1210 is used to store and retrieve information for a block 232 and the block 232 communicates directly with the persistence module 1210.

It is noted that, while the block 232 or other component of the NIO platform 402 may be configured to write information directly to the persistence storage 1208 and retrieve information directly from the persistence storage 1208 as described with respect to FIGS. 12 and 13, this does not mean they can access the saved information after restart. In other words, the block 232 may be able to directly write to and read from the persistence storage 1208 during the current instantiation of the block 232, but directly accessing the same persistence storage 1208 after a restart would require that the block 232 know the location of the persistence storage 1208.

Accordingly, for the block 232 to be able to recover information directly from the persistence storage 1208 after a restart, such location knowledge would have to be available to the block 232. While embodiments of the NIO platform may be implemented to pass the location information to the block 232 after the block 232 is restarted (e.g., from the core 228 to the service 230 via the SIC, and from the service 230 to the block 232 via the BIC), the current embodiment of the NIO platform 402 provides an alternate solution using the persistence module 1210.

As previously described, the NIO platform 402 may use modules to provide additional functionality across an entire NIO platform instance. Accordingly, the persistence module 1210 provides at least two advantages to the NIO platform 402. First, the persistence module 1210 can be modified to change how the persistence itself is accomplished without having to make changes to service or block structures. As previously described, a module can be modified and that modification affects the functionality of the module across the entire NIO platform instance. Second, the persistence module 1210 can be used to store persistence information in a consistent manner regardless of the particular block 232 that needs such functionality and, therefore, the information can be consistently retrieved even after a restart occurs. This enables the block 202 and other components of the NIO platform 402 to incorporate the persistence storage functionality of the persistence module 1210 in a standardized manner with minimal user effort.

Continuing with the example of FIG. 14, the service 230 loads the persistence module 1210 as part of the service process and then configures the persistence module 1210 for use by blocks 232 within the service 230. Accordingly, in steps 1402 and 1404, the service 230 configures the persistence module 1210 and the block 232, respectively. In step 1406, the block 232 can then communicate directly with the persistence module 1210 to store and/or retrieve persistence information. If information is retrieved in step 1406, the information is loaded by the block 232 in step 1408.

Referring to FIG. 15, a sequence diagram 1500 illustrates another embodiment of a process that may be used to provide information persistence within a NIO platform (e.g., the NIO platform 402 of FIG. 4). In the present example, the persistence module 1210 is used to store and retrieve information for a block 232, and the block 232 interacts indirectly with the persistence module 1210. Accordingly, in steps 1502 and 1504, the service 230 configures the persistence module 1210 and block 232, respectively. In step 1506, the block 232 requests from the service 230 that persistence information be stored or retrieved. In step 1508, the service 230 communicates with the persistence module 1210 to handle the request. In step 1510, the service 230 returns the information to the block 232 or, if a save request was received, may acknowledge the request and/or inform the block 232 that the information has been saved. In step 1512, the block 232 loads the information for use if step 1510 returned retrieved information.

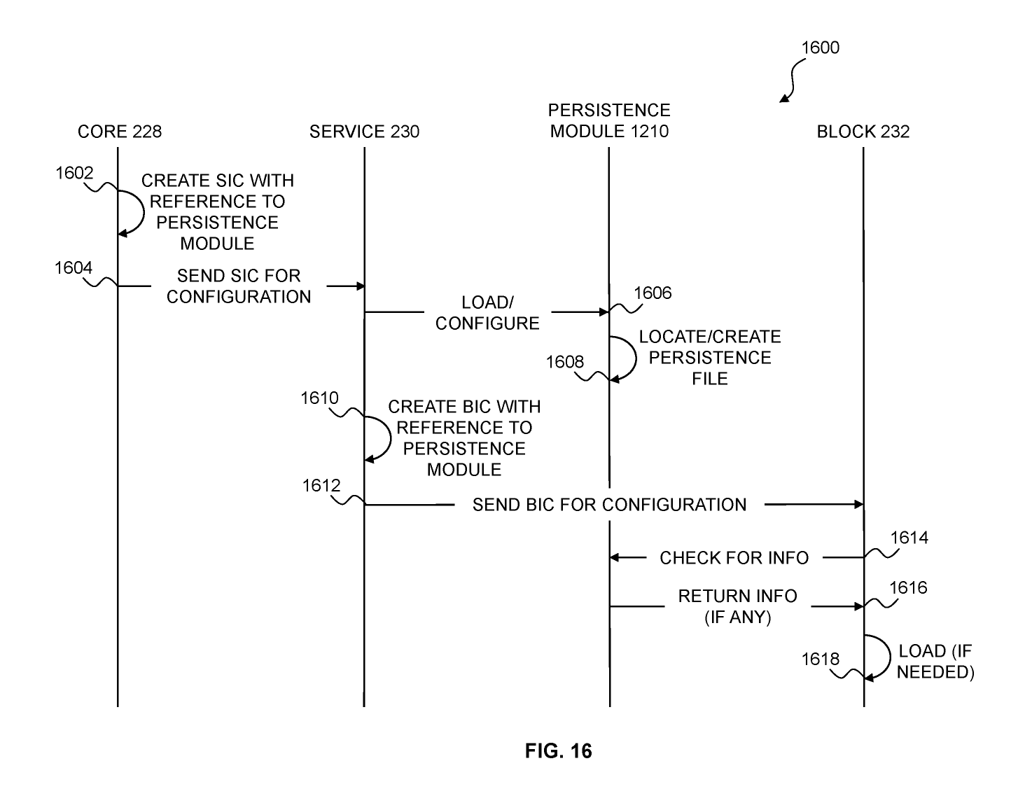

Referring to FIG. 16, a sequence diagram 1600 illustrates another embodiment of a process that may be used to provide information persistence within a NIO platform (e.g., the NIO platform 402 of FIG. 4). In the present example, the persistence module 1210 is used to store and retrieve information for a block 232 and the block 232 communicates directly with the persistence module 1210.

In step 1602, the core 228 creates a SIC for the service 230. As previously described, this occurs after the persistence module 1210 has been discovered and initialized. Accordingly, the SIC contains information about the persistence module 1210 that is needed by the service 230. In step 1604, the core 228 sends the SIC to the service 230 for configuration. In step 1606, the service 230 loads the persistence module 1210 and configures the persistence module 1210 for use. The configuration may include the service 230 assigning an identifier to the persistence module 1210 and/or setting various parameters. For example, the service 230 may assign the name of the service itself as the identifier for the persistence module 1210.

In step 1608, the persistence module 1210 attempts to locate an existing persistence file using the assigned name or another identifier. If a persistence file currently exists, there is generally no need to create one. If no existing persistence file is located, the persistence module 1210 may create a persistence file. In other embodiments, the persistence module 1210 may wait until it receives information to be saved before creating a persistence file.

In steps 1610 and 1612, respectively, the service 230 creates a BIC for the block 232 and sends the BIC to the block 232. The BIC may contain information identifying the persistence module 1210, any values to be persisted by the block 232, and similar information. It is understood that one or both of steps 1610 and 1612 may occur before or simultaneously with steps 1606 and/or 1608.

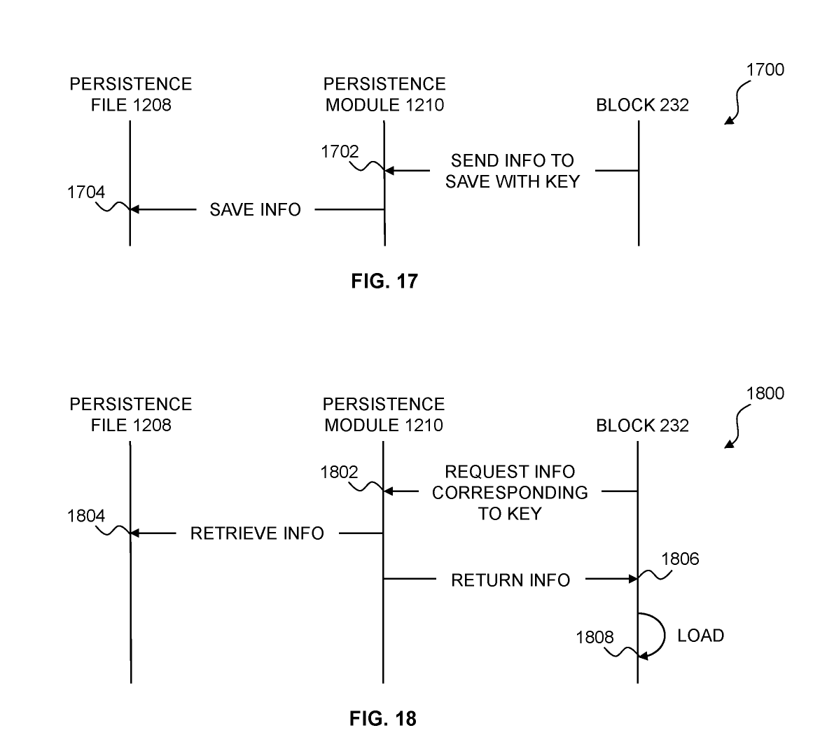

In step 1614, the block 232 checks with the persistence module 1210 for any persistence information that the persistence module 1210 may have for the block 232. It is noted that this initial request may not be repeated since the purpose is to determine if there is any persistence information following block startup. In step 1616, the persistence module 1210 returns any information it may have for the block 232. In step 1618, the block 232 loads any information received. Following one or more of steps 1614, 1616, and 1618 (depending on whether there is stored persistence information to be loaded), the block 232 may use the persistence module 1210 to save and retrieve persistence information as described below with respect to FIGS. 17 and 18.

In the present example, each service 230 of the NIO platform 402 includes the persistence module 1210. Furthermore, each block 232 has the instructions needed to communicate with the persistence module 1210 to save and load information, even if the functionality is not used. Accordingly, steps 1614, 1616, and 1618 may only be performed at startup for blocks configured to use the persistence module 1210. Other blocks would receive the information about the persistence module 1210 in step 1612, but would not use it.

It is understood that other embodiments may not force this functionality on all services and/or blocks. In such embodiments, based on the particular configuration of the service 230 and its blocks 232, one or both of steps 1602 and 1610 may not even include the information about the persistence module 1210 in the context being created. In some embodiments, the base block class may include instructions needed to create a persistence object that includes the calls needed to use the persistence module 1210. In other embodiments, the base block class may contain no such instructions, and users may have to specifically add instructions to each block for which persistence functionality is desired (e.g., via a mixin or other otherwise).

Referring to FIG. 17, a sequence diagram 1700 illustrates another embodiment of a process that may occur following step 1618 of FIG. 16 to provide information persistence within the NIO platform 402. In the present example, the persistence module 1210 is used to store information for the block 232. It is understood that the persistence module 1210 may handle the saving and retrieving of information in many different ways. For example, the persistence module 1210 may use a unique persistence file 1208 for each block 232 or may use a single persistence file 1208 for multiple blocks 232 with information for each block distinguished within the persistence file from information for other blocks. For purposes of illustration, the persistence module 1210 uses a single persistence file based on key/value pairs. Each key is an identifier for a particular block within the service 230 (e.g., the block's name) and is associated with a corresponding value or set of values representing the block's data within the persistence file 1208.

Accordingly, in step 1702, the block 232 sends information to be stored to the persistence module 1210 using the key/value pairing described previously. For example, the block 232 may send a niogram with block_name and dictionary as the name/value pair, where the dictionary contains variables and corresponding values at the time the save is performed. In step 1704, the persistence module 1210 saves this information to the persistence file 1208.

Referring to FIG. 18, a sequence diagram 1800 illustrates another embodiment of a process that may occur following step 1618 of FIG. 16 to provide information persistence within the NIO platform 402. In the present example, the persistence module 1210 is used to retrieve information for the block 232. Accordingly, in step 1802, the block 232 requests stored information from the persistence module 1210 using the key/value pairing described previously. In steps 1804 and 1806, respectively, the persistence module 1210 retrieves this information from the persistence file 1208 and returns it to the block 232. In step 1808, the block 232 loads the information.

In some embodiments, the persistence module 1210 may prefetch persistence information (e.g., in step 1608 of FIG. 16) and it is understood that step 1804 would occur before step 1802 in such embodiments. For example, the persistence module 1210 may load all existing persistence information into memory following the persistence module's configuration, and this information would then be available for retrieval by a block without the persistence module 1210 having to access the persistence file 1208 following the block's request.

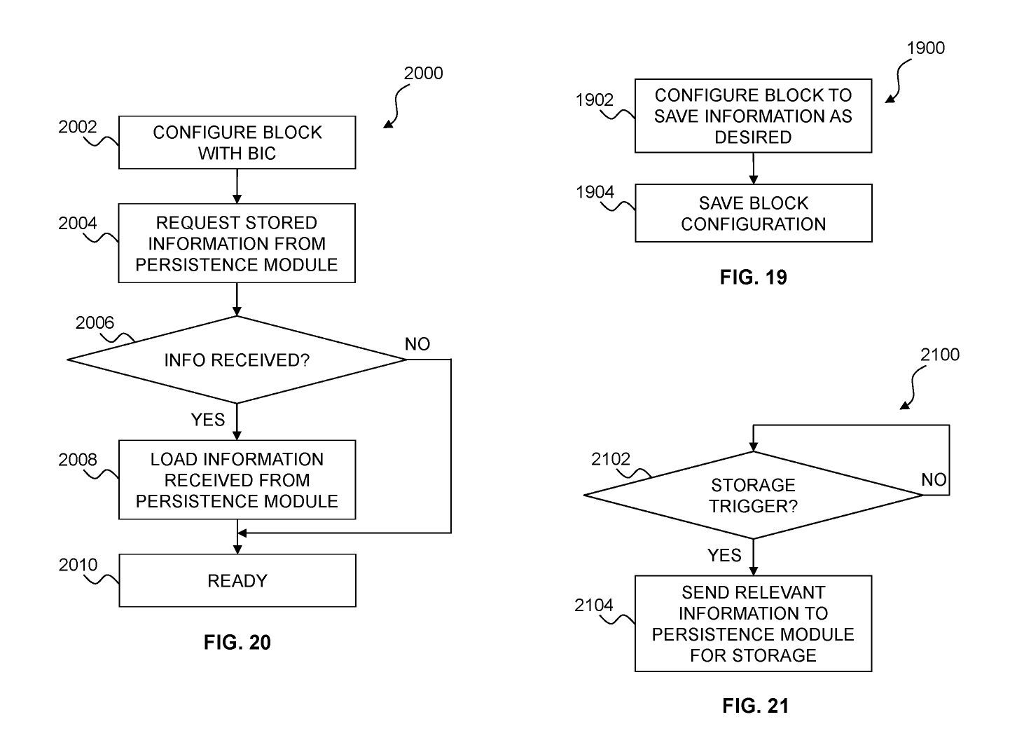

Referring to FIG. 19, a method 1900 illustrates one embodiment of a process that may be executed to configure a block 232 to save persistence information. In step 1902, the block 232 is configured to save information as desired. For example, the block 232 may be configured to use the persistence module 1210 and to save a defined set of variable values upon the occurrence of one or more defined events. In step 1904, the configured block 232 is saved. When run by the NIO platform 402, the block 232 will persist the information using the persistence module 1210 based on the block's configuration.

Referring to FIG. 20, a method 2000 illustrates one embodiment of a process that may be executed by a block 232 within the NIO platform 402 when the block is started. In step 2002, the block 232 is configured using the BIC provided by the service 230. In step 2004, the block 232 requests any information that the persistence module 1210 may have for the block. In step 2006, based on whether information was received in response to the request in step 2004, the method 2000 moves to either step 2008 or 2010. If information was received, the block 232 loads the information for use in step 2008 and is then ready for operation in step 2010. If no information was received, the method 2000 moves directly to step 2010.

Referring to FIG. 21, a method 2100 illustrates one embodiment of a process that may be executed by a block 232 within the NIO platform 402 when the block is running (e.g., after the method 2000 of FIG. 20 is executed). In step 2102, a determination is made as to whether a storage trigger has occurred. If no storage trigger has occurred, the method 2100 repeats step 2102 until a storage trigger occurs or the block 232 is stopped. If a storage trigger has occurred, the method 2100 continues to step 2104, where information is sent to the persistence module 1210 for storage. For example, the block 232 may send one or more key/value pairs for storage.

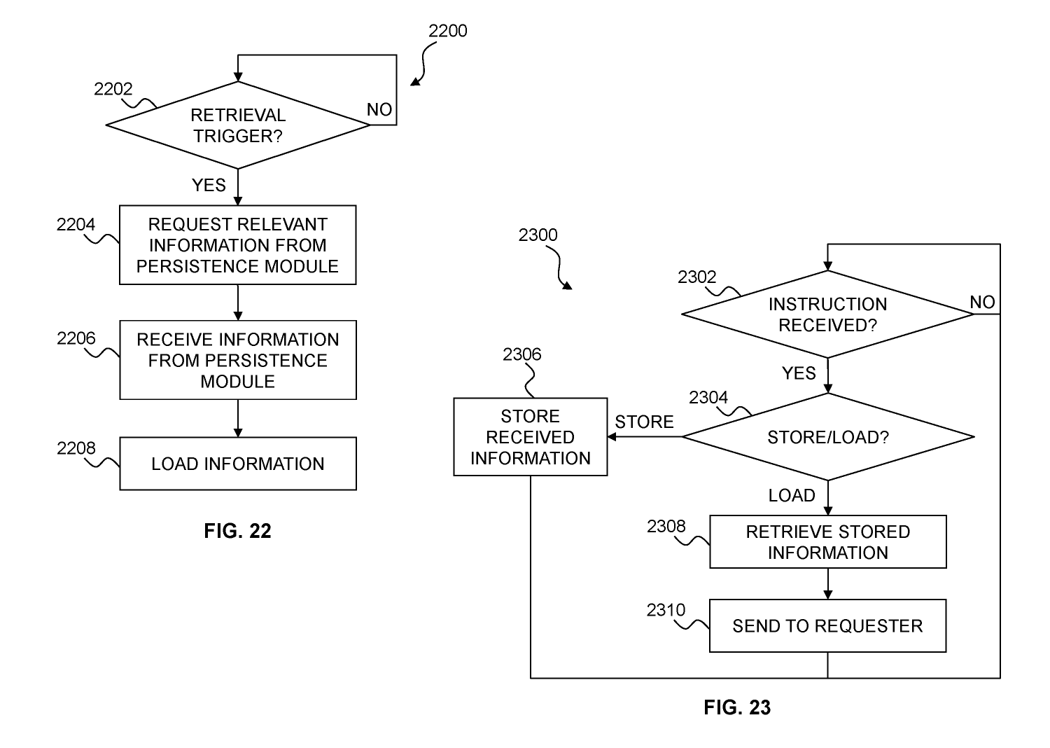

Referring to FIG. 22, a method 2200 illustrates one embodiment of a process that may be executed by a block 232 within the NIO platform 402 when the block is running (e.g., after the method 2000 of FIG. 20 is executed). In step 2202, a determination is made as to whether a retrieval trigger has occurred. If no retrieval trigger has occurred, the method 2200 repeats step 2202 until a retrieval trigger occurs or the block 232 is stopped. If a retrieval trigger has occurred, the method 2200 continues to step 2204, where the block 232 requests information from the persistence module 1210. It is understood that the request may be for all saved information or for only certain portions of the saved information. In step 2206, the information is received from the persistence module. In step 2208, the received information is loaded for use by the block 232.

Referring to FIG. 23, a method 2300 illustrates one embodiment of a process that may be executed by the persistence module 1210 within the NIO platform 402. In step 2302, a determination is made as to whether an instruction has been received. If no instruction has been received, the method 2300 repeats step 2302 until an instruction is received or the persistence module 1210 is stopped. If an instruction has been received (as determined in step 2302) and the instruction is a store instruction (as determined in step 2304), the method 2300 moves to step 2306, where the information is stored in the persistence file 1208 (or other storage, such as a database). The method 2300 then returns to step 2302.

If an instruction has been received (as determined in step 2302) and the instruction is a load instruction (as determined in step 2304), the method 2300 moves to step 2308, where the information is retrieved from the persistence file 1208 (or other storage, such as a database). In step 2310, the retrieved information is sent to the requestor, whether a block 232 or another component of the NIO platform 402. The method 2300 then returns to step 2302. In some embodiments, the persistence module 1210 may prefetch persistence information (e.g., in step 1608 of FIG. 16) and it is understood that step 2308 would occur before step 2304 and/or step 2302 in such embodiments.

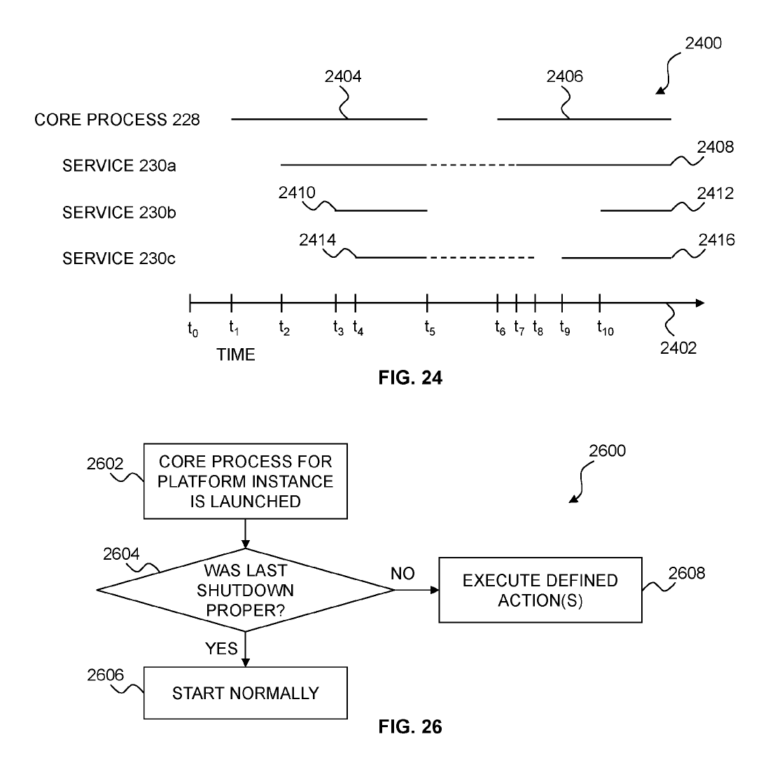

Referring to FIG. 24, one embodiment of a diagram 2400 illustrates a core process 228 and services 230a, 230b, and 230c plotted against an axis 2402 representing time. More specifically, the diagram 2400 illustrates examples of stop and start times for the core process 228 and the services 230a, 230b, and 230c of a NIO platform instance 402 relative to one another. In this example, the core 228 and the services 230a, 230b, and 230c are separate processes.

At time t₀, the NIO platform instance 402 is not running. At time t₁, the NIO platform instance 402 is started when the core process 228 is launched as indicated by line 2404. The service 230a is started at time t₂ as indicated by line 2408, the service 230b is started at time t₃ as indicated by line 2410, and the service 230c is started at time t₄ as indicated by line 2414. Accordingly, following time t₄, the core 228 and the services 230a, 230b, and 230c are running as separate processes.

In embodiments of the NIO platform 402 where the core 228 and the services 230a, 230b, and 230c are separate processes, the core 228 generally shuts down the service processes as part of the shutdown process for the NIO platform instance 402. This orderly shutdown process allows persistence data to be saved, other instances to be notified of the shutdown, and/or similar actions to be taken in order before the service processes are stopped. The core process 228 is then terminated to complete the shutdown of the NIO platform instance 402.

However, it is possible for one or more of the services 230a, 230b, and 230c to continue running when the core 228 has malfunctioned. A malfunction can occur when the core process 228 ends without properly shutting down or becomes non-responsive even though it has not ended. Such a malfunction is illustrated in FIG. 24 at time t₅. When this occurs, the services 230a, 230b, and 230c that were running at the time the core 228 malfunctioned may continue running in some situations. For example, if the operating system 122 of the device on which the NIO platform 402 is running continues to operate normally, the services 230a, 230b, and 230c may continue to run since they are separate processes from the core process 228. In the present embodiment, the services 230a and 230c continue running past time t₅.

While some services may continue running, other services may crash if the core process 228 crashes. For example, if the service is communicating with the core process 228 or is dependent upon functionality provided by the core process 228 (e.g., functionality provided by a core component 502), the service may crash when the core 228 becomes unavailable. In the present example, the service 230b ends at time t₅ without being properly shut down.

Although the services 230a and 230c are still running after the core process 228 ends, one or both of the services can be shut down without using the core 228 (e.g., by terminating the services via the operating system's process list) or can be allowed to continue running. As a service process can be relatively self-sufficient once it is launched by the core 228, the services 230a and 230c may continue to function normally. However, since external control of the services 230a and 230c is generally maintained only through the core 228 (e.g., the REST API), the ability to update, start/stop, and otherwise control the services 230a and 230c is not available when the core 228 is no longer running unless the service is specifically designed with additional control capabilities. The dashed portions of lines 2408 and 2414 illustrate the time periods during which the services 230a and 230c, respectively, are running but are not under the control of the core process 228.

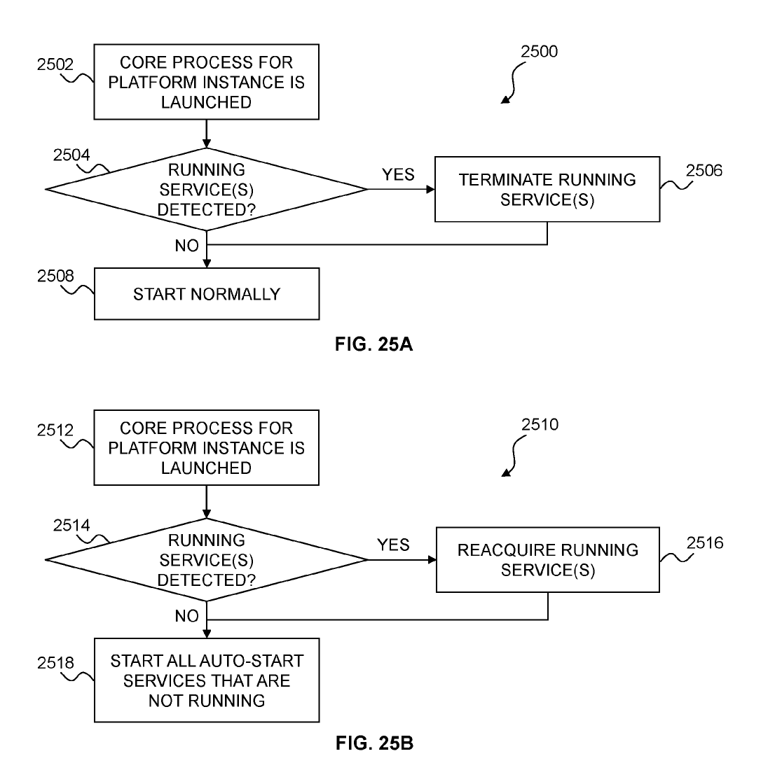

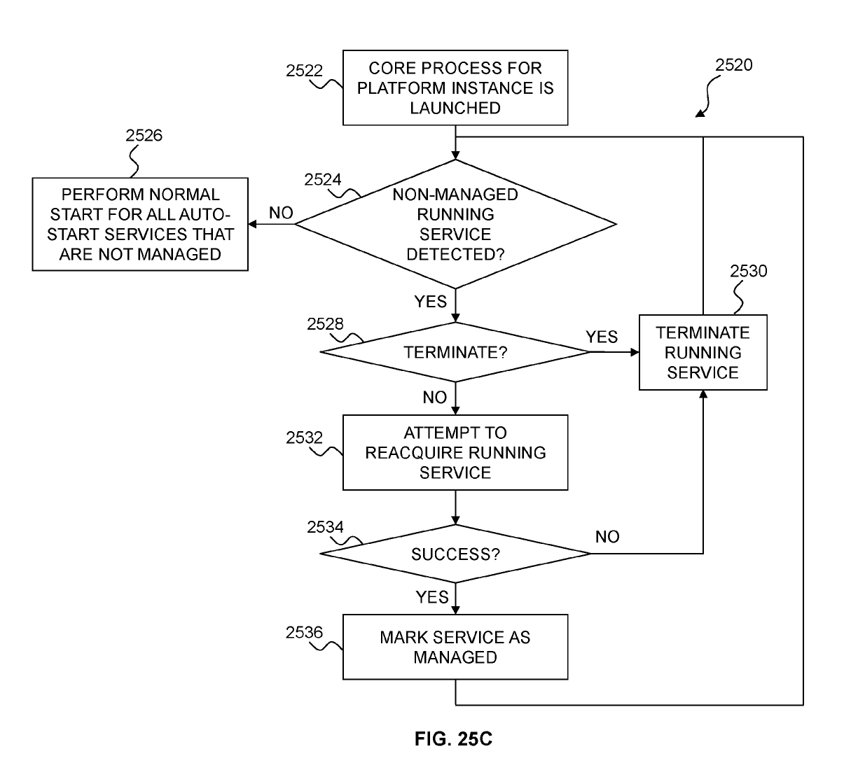

When the NIO platform instance 402 is restarted, any previously launched services that are still running may cause issues due to their use of operating system/device resources, may cause instability or other issues for the restarted NIO platform 402 (e.g., by interfering with newly launched services), and/or may cause other problems. Therefore, for these and other reasons, it may be desirable for the NIO platform 402 to take specific steps when restarted in order to account for any currently running services. When restarted, the NIO platform 402 may locate and terminate any running services (as will be described below with respect to FIG. 25A), may attempt to reacquire the services (as will be described below with respect to FIG. 25B), or may use a process with both termination and reacquisition options (as will be described below with respect to FIG. 25C).

Continuing the present example, the core process 228 is restarted at time t₆. The core 228 successfully reacquires the service 230a at time t₇. The core 228 does not reacquire the service 230c, so it terminates the service process for the service 230c at time t₈ and restarts the service 230c at time t₉. At time t₁₀, the core 228 restarts the service 230b. Accordingly, following time t₁₀, the core 228 and the services 230a, 230b, and 230c are again running with the core 228 able to communicate with the services 230a, 230b, and 230c.

Referring to FIGS. 25A-25C, different methods illustrate embodiments of a process that may be executed by the NIO platform 402 after the core 228 malfunctions and the NIO platform 402 is restarted. However, before describing FIGS. 25A-25C in detail, reference is made to FIG. 26, in which a method 2600 illustrates one embodiment of a process that may be executed by the NIO platform 402 when the NIO platform 402 is started.

It is understood that the NIO platform 402 may only perform the processes of FIGS. 25A-25C if the last shutdown was improper. While the processes of FIGS. 25A-25C may always be performed in some embodiments, this may slow down the startup process of the NIO platform 402 unnecessarily if the NIO platform 402 was correctly shut down prior to the current startup process. Therefore, the method 2600 may be used to determine whether one of the methods of FIGS. 25A-25C is to be executed.

Accordingly, in step 2602, the NIO platform instance 402 is started. In step 2604, a determination is made as to whether the last shutdown of the NIO platform 402 was proper. For example, during a proper shutdown of an instance of the NIO platform 402, the core 228 may set a flag bit, may make a notation in a log file or a configuration file, and/or may use another indicator to record that the shutdown was proper. In such cases, during startup, the core process can check the indicator to determine if the last shutdown was proper. In embodiments where the NIO platform 402 is to be started normally even if the last shutdown was improper or in embodiments where one of the methods of FIGS. 25A-25C is to be executed even if the last shutdown was proper, the functionality provided by FIG. 26 may be omitted or the indicator(s) may be set to a default state (e.g., to always indicate that the last shutdown was proper or improper in order to trigger a desired action by the core 228).

If the last shutdown was proper as determined in step 2604, the method 2600 continues to step 2606. In step 2606, the NIO platform 402 is started normally. If the last shutdown was improper, the method 2600 continues to step 2608. In step 2608, one or more defined actions are executed, such as one of the methods of FIGS. 25A-25C. Although each of the methods of FIGS. 25A-25C includes a first step that is identical to step 2602 of FIG. 26, it is understood that this is for purposes of illustration in each of the figures and that the step is only executed a single time.

Referring specifically to FIG. 25A, a method 2500 illustrates one embodiment of a process that may be executed by the NIO platform 402 when the NIO platform 402 is started. The method 2500 may be used, for example, in embodiments where it is not possible to reacquire a service 230 (e.g., when the NIO platform 402 is not configured to enable a service 230 to be reacquired and/or the operating system 122 does not support the needed functionality), when there is no need to do so (e.g., because there is no advantage to reacquiring a running service 230), or when it is more efficient to restart the service 230 normally than to reacquire the service.

Accordingly, in step 2502, the core process for the NIO platform instance 402 is launched. In step 2504, the method 2500 checks to see if there are any services 230 already running on the device. For example, the method 2500 may check a process list maintained by the operating system 122 for processes having particular names or may check to see if there is stored information indicating that services 230 may be running. As will be described later in greater detail, the method 2500 may also check to make sure that any running services 230 are not associated with another instance, as the current NIO platform instance 402 would typically not want to begin terminating the services 230 of other instances.

If there are running services 230 as determined in step 2504 (and they are not associated with another instance if the additional check is performed), the method 2500 moves to step 2506. In step 2506, the running services 230 are terminated via the operating system 122 or using another process. The method 2500 then moves to step 2508, where the NIO platform 402 continues the normal startup process described in previous embodiments. If there are no running services 230 as determined in step 2504, the method 2500 moves directly to step 2508 and continues the normal startup process.

Referring specifically to FIG. 25B, a method 2510 illustrates one embodiment of a process that may be executed by the NIO platform 402 when the NIO platform 402 is started. The method 2510 may be used, for example, in embodiments where it is possible to reacquire a service 230.

Accordingly, in step 2512, the core process for the NIO platform instance 402 is launched. In step 2514, the method 2510 checks to see if there are any services 230 already running on the device. For example, the method 2510 may check a process list maintained by the operating system 122 for processes having particular names or may check to see if there is stored information indicating that services 230 may be running. As will be described later in greater detail, the method 2510 may also check to make sure that any running services 230 are not associated with another instance, as the current NIO platform instance 402 would typically not want to attempt to acquire control over the services 230 of other instances.

If there are running services 230 as determined in step 2514 (and they are not associated with another instance if the additional check is performed), the method 2510 moves to step 2516. In step 2516, the NIO platform instance 402 reacquires the running services 230. More detailed examples of step 2516 are described in following embodiments. The method 2510 then moves to step 2518, where the NIO platform 402 continues the normal startup process for any other services 230 that are listed as auto-start and are not already running. If there are no running services 230 as determined in step 2514, the method 2510 moves directly to step 2518 and continues the normal startup process.

Referring specifically to FIG. 25C, a method 2520 illustrates one embodiment of a process that may be executed by the NIO platform 402 when the NIO platform 402 is started. The method 2520 illustrates a combination of the methods of FIGS. 25A and 25B in that a running service 230 may either be reacquired or terminated.

Accordingly, in step 2522, the core process for the NIO platform instance 402 is launched. In step 2524, the method 2520 checks to see if there are any non-managed services 230 already running on the device. In the present example, a non-managed service 230 is a running service 230 that corresponds to the current NIO platform 402 but has not been reacquired. For example, the method 2520 may check a process list maintained by the operating system 122 for processes having particular names or may check to see if there is stored information indicating that services 230 may be running. If there are no non-managed running services 230 as determined in step 2524, the method 2520 moves to step 2526. In step 2526, all services 230 that are listed as auto-start are started normally.

For each non-managed service 230, one of three process loops may be executed. The first loop is directed to terminating the service 230 and includes steps 2524, 2528, and 2530. The second loop is directed to successfully reacquiring the service 230 and includes steps 2524, 2528, 2532, 2534, and 2536. The third loop is directed to unsuccessfully attempting to reacquire the service 230 and includes steps 2524, 2528, 2532, 2534, and 2530.

The loop selected for a particular service 230 may be based on a configuration of the NIO platform 402 that controls the process for all services 230 or for only that particular service 230. For example, the NIO platform 402 may be configured to treat all services 230 in the same way, such as using a hierarchical approach where the NIO platform 402 will always try to reacquire a non-managed service and will terminate the service 230 only if unsuccessful. Alternately, the NIO platform 402 may be configured to simply terminate all non-managed services.

In other embodiments, the NIO platform 402 may be configured to handle some or all services 230 uniquely. For example, each service 230 may have a particular configuration that defines how to handle that service 230 if the service is in a non-managed state, or multiple services 230 may be grouped into configurations where all services 230 in the group are handled in the same manner. This enables a NIO platform 402 to be configured as desired in order to define whether a particular service 230 should simply be terminated or an attempt should be made to reacquire the service. It is noted that the NIO platform 402 may also be configured to automatically assign actions to different services 230 based on the input, processing, and/or output capabilities of each of the services 230.

For example, one service 230 may rely on user input received via the REST API. Because the core process 228 crashed, that service 230 has not been receiving any input. Therefore, restarting the service 230 will not result in the loss of any data and might even be more efficient than attempting to reacquire the service 230. However, another service 230 may be receiving information at a relatively constant rate from a streaming media producer, processing that data, and streaming the processed data to a web server for display. In this case, terminating the service 230 would likely interrupt the display provided by the web server and so it may be desirable to reacquire the service 230 to avoid such an interruption.

In another example, a service 230 may be one of a chain of services 230 that operate together. If some of the services 230 in the chain have continued running and others have crashed, it may be more efficient to terminate the running services 230 and restart the entire chain of services 230. Alternatively, it may be more efficient to start only the services 230 that crashed and to reacquire the still running services 230. Accordingly, by allowing a user to define how a particular non-managed service 230 should be handled at startup and/or by defining one or more default handling processes for the NIO platform 402, the NIO platform 402 can be configured as desired.

If there is a non-managed running service 230 as determined in step 2524, the method 2520 moves to step 2528. In step 2528, a determination is made as to whether to terminate the service 230. If the service 230 is to be terminated as determined in step 2528, the method 2520 moves to step 2530. In step 2530, the service 230 is terminated and the method 2500 returns to step 2524.

If the service 230 is not to be terminated as determined in step 2528, the method 2520 moves to step 2532. In step 2532, an attempt is made to reacquire the service 230. The method 2520 then moves to step 2534. If the attempt to reacquire the service 230 is successful as determined in step 2534, the method 2520 moves to step 2536. In step 2536, the service 230 is marked as managed to indicate that the service 230 has been reacquired. The method 2520 then returns to step 2524. If the attempt to reacquire the service 230 is not successful as determined in step 2534, the method 2520 moves to step 2530. In step 2530, the service 230 is terminated and the method 2520 then returns to step 2524.

Once all the non-managed services 230 that are running have been either reacquired or terminated, the method 2520 moves to step 2526. Any auto-start services 230 that are not managed services 230 (e.g., services 230 that are already running and reacquired) are started normally, while any managed services 230 are skipped. In some embodiments, the managed services 230 may be updated if needed during step 2526 unless an update was performed earlier in the process. For example, a service 230 that has been reacquired may be updated during or following steps 2532, 2534, and 2536. In other embodiments, such updates may not be needed.

It is understood that the order of the steps may be altered and various steps may be modified. For example, step 2528 may be a determination as to whether to reacquire the service 230 rather than terminate the service, in which case step 2530 would be the result of a “NO” determination and step 2532 would be the result of a “YES” determination. In still other embodiments, step 2534 may be omitted and failure to reacquire a service 230 may be result in the service 230 being ignored by the NIO platform 402 rather than terminated. In such embodiments, the service 230 may be removed from a list of non-managed services to prevent the method 2520 from looping repeatedly while trying to reacquire the service 230.

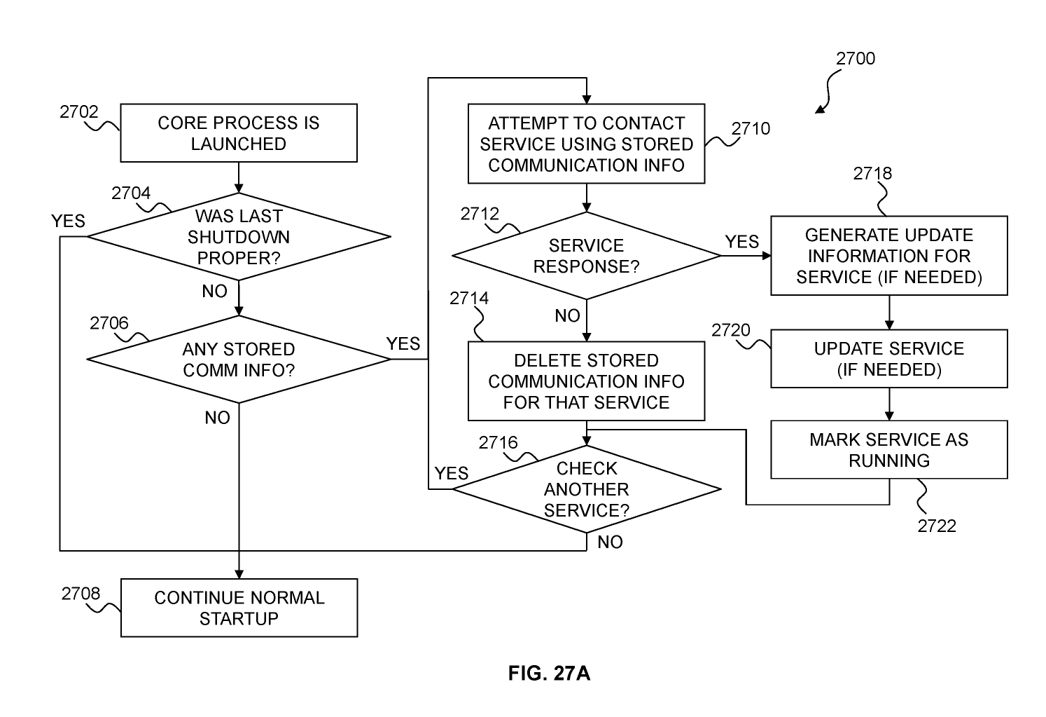

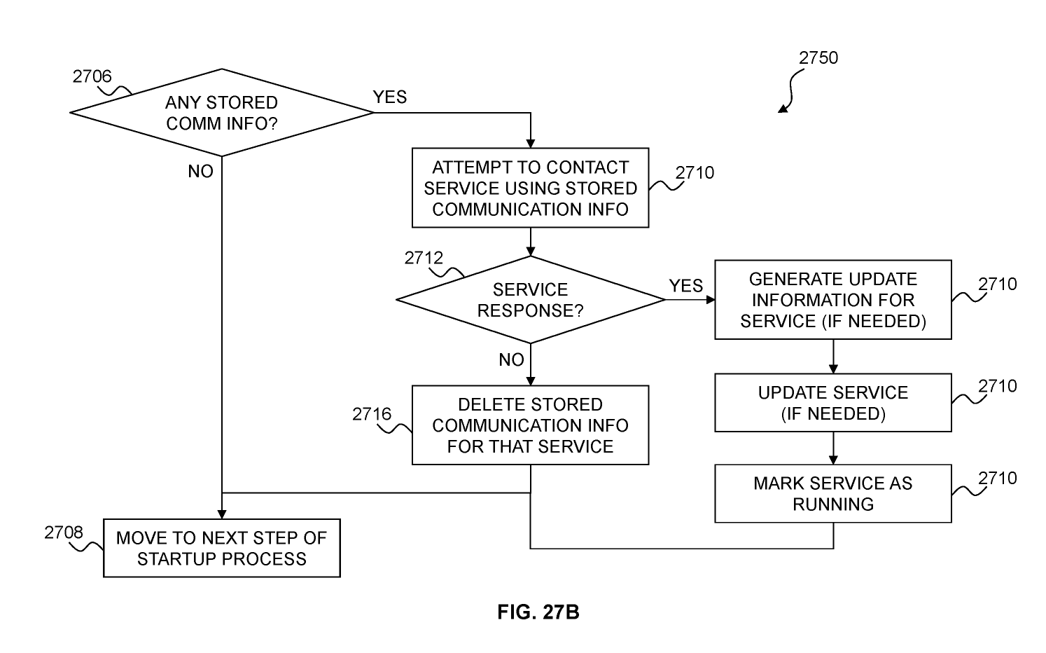

Referring to FIG. 27A, a method 2700 illustrates one embodiment of a process that may be executed by the NIO platform 402 when the NIO platform 402 is started. The method 2700 illustrates a more detailed embodiment of FIG. 25B in which the NIO platform 402 attempts to reacquire a running service 230 after a platform restart. Although not shown, it is understood that additional steps may be implemented with the method 2700 for terminating a service 230 as described previously with respect to FIG. 25C.

In step 2702, the core process 228 is launched to begin the startup process for the NIO platform 402. In step 2704, a determination is made as to whether the last shutdown of the NIO platform 402 was proper (as described with respect to FIG. 26). The timing of step 2704 during the startup process may vary based on the particular implementation of the method 2700. For example, the core 228 may begin to run through the startup process as described in previous embodiments until the startup process reaches the point where services 230 are started. More specifically, the core 228 may execute steps 1-3 of Table 2 and stop before beginning step 4 in order to execute step 2704. In another example, step 2704 may be performed earlier in the startup process (e.g., before or during step 3 of Table 2) or may be performed on a per service basis (e.g., before step 4 for each service).

If the last shutdown was proper, the method 2700 moves to step 2708 and proceeds with the normal startup process as described in previous embodiments. If the last shutdown was not proper, the method 2700 moves to step 2706. In step 2706, a determination is made as to whether there is any stored communication information that may be used to reestablish communication with a running service 230.

In order to reacquire a service 230, the restarted NIO platform 402 must be able to communicate with the service 230. This generally requires the availability of a previously established communication channel corresponding to the service 230 that can be used by the restarted core 228. The particular way in which communication may be reestablished depends on the type of channel and how that channel works. For example, if the service 230 is associated with a named IPC pipe, then the NIO platform 402 may store the information needed to access the named channel. This stored information would be available on restart and could be checked by the core 228 in step 2706. If the NIO platform instance 402 is properly shut down, such information would be deleted during the shutdown process and there would be no information to find in step 2706. Other communication channels include the use of files, shared or mapped memory locations, a message queue maintained by the operating system 122, and/or other IPC approaches that have some level of persistence that enables the channel to survive if the core 228 malfunctions and is restarted. Such channels may be process-to-process or may use a publication or broadcast channel model.

It is understood that a channel may be established solely for reestablishing communication after a restart when the service 230 is still running, and other channels may be used for regular communications (e.g., an IPC pipe that does not survive termination of the core process 228). The use of a special channel for recovery communications and one or more other channels for regular communications enables a great deal of flexibility in how the regular communications are performed, as they are not limited by the requirement of persistence. For example, if a named pipe is used for recovery purposes, a regular (e.g., un-named) pipe can be used for regular operations when persistence is not important. In other embodiments, a single IPC approach may be used for all communications with a service 230. Whether the selected approach is capable of recovery would then be based on whether recovery is needed for the particular service(s) 230 and/or the particular implementation of the NIO platform 402.

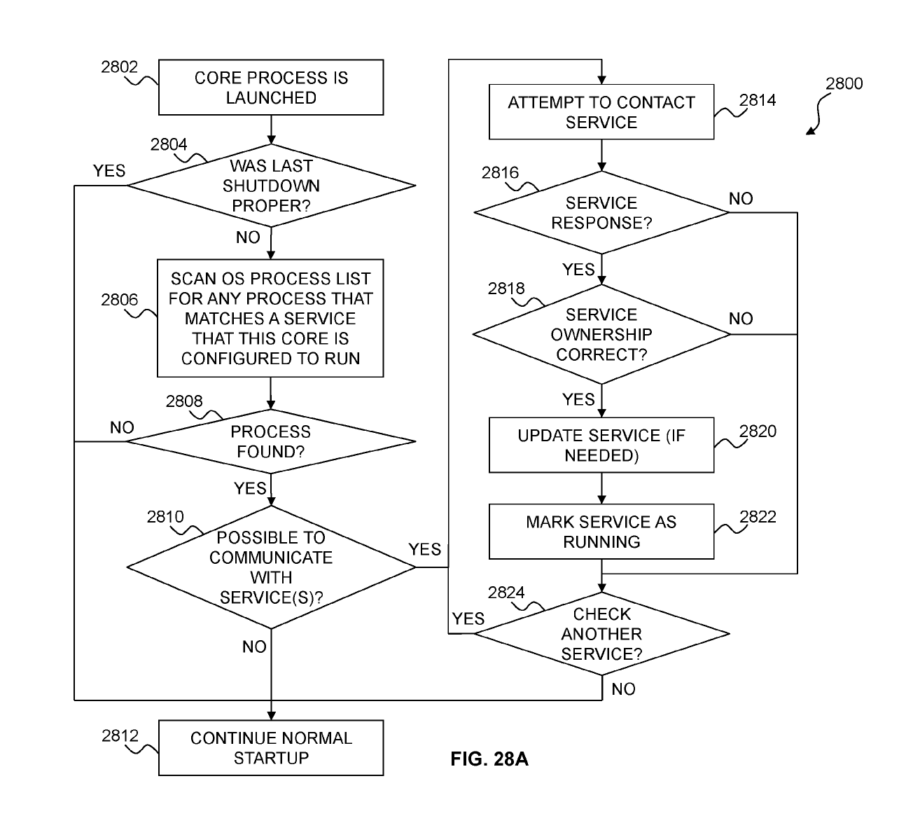

Accordingly, regardless of the particular implementation of the communication channel, the determination of step 2706 identifies whether such communication information needed to communicate with one or more services 230 is available. It is noted that if the communication information is maintained by the NIO platform 402, the core 228 can examine the communication information to see if any services 230 were in use with persistent communication channels, and such services 230 can be checked after the restart to see if there is a response. As only services 230 associated with the NIO platform 402 will be in the communication information maintained by the NIO platform 402, there is no need to check whether a service 230 belongs to that particular instance. If the communication information is not controlled by the NIO platform 402 and may contain other processes (e.g., services 230 belonging to other NIO platform instances), such a check may need to be performed as will be described with respect to FIG. 28A.

If no communication information is available as determined in step 2706, the method 2700 moves to step 2708 and proceeds with the normal startup process. If such communication information is available, the method 2700 moves to step 2710. In step 2710, an attempt is made to contact the service 230 using the stored communication information.

In step 2712, a determination is made as to whether there is a response from the service 230. If there is no response, the communication information for that service 230 is deleted in step 2714. It is understood that the stored communication information is deleted only if controlled by the NIO platform 402, and so step 2714 may not be performed in some implementations of the method 2700. For example, if the communication information is controlled by the operating system 122, the NIO platform 402 may not be able to delete the communication information, particularly if the service 230 is still running (e.g., the service process may have to be stopped first).

In step 2716, a determination may be made as to whether there is another service 230 to be checked. For example, if the communication information includes multiple services 230, each service may be checked. Accordingly, if there is not another service 230 to be checked, the method 2700 moves to step 2708. If there is another service 230 to be checked, the method 2700 returns to step 2710.

If a response is received as determined in step 2712, the method 2700 moves to step 2718. In step 2718, update information may be generated for the service 230. For example, a new SIC may be generated for the service 230 without actually starting the service again. In step 2720, the update information is passed to the service 230. This enables the core 228 to pass information to the service 230 that may have changed when the NIO platform instance 402 was restarted, such as new information about the modules 504, available IP addresses, and/or similar environmental information. In step 2722, the service 230 is marked as running. This prevents the core 228 from attempting to start the service 230 if the service is listed as auto-start or if a start command is received, and also enables the NIO platform 402 to stop the service 230 if desired. The method 2700 then continues to step 2716.

Referring to FIG. 27B, a method 2750 illustrates another embodiment of FIG. 27A. In the present embodiment, the functionality provided by the method 2750 is illustrated as being applied on a per service basis during startup. Accordingly, step 2708 may be used to move the startup process to the startup step for the next service (which may include returning to step 2706) or to another step in the startup process. For example, for each service 230, the method 2750 would be executed, and may be executed in parallel for different services 230. In such an embodiment, step 2706 may be modified to prevent a running service 230 that has been recently started or reacquired from being processed using the method 2750. As the steps are numbered with the same reference numerals as are used in FIG. 27A and have the same functionality as previously described, the steps are not described in detail in the present embodiment.

Referring to FIG. 28A, a method 2800 illustrates one embodiment of a process that may be executed by the NIO platform 402 when the NIO platform 402 is started. The method 2800 illustrates a more detailed embodiment of FIG. 25B in which the NIO platform 402 attempts to reacquire a running service 230 after a platform restart. Although not shown, it is understood that additional steps may be implemented with the method 2800 for terminating a service 230 as described previously with respect to FIG. 25C.

In step 2802, the core process 228 is launched to begin the startup process for the NIO platform 402. In step 2804, a determination is made as to whether the last shutdown of the NIO platform 402 was proper (as described with respect to FIG. 26). As described with respect to step 2704 of FIG. 27A, the timing of step 2804 during the startup process may vary.

If the last shutdown was proper, the method 2800 moves to step 2812 and proceeds with the normal startup process as described in previous embodiments. If the last shutdown was not proper, the method 2800 moves to step 2806. In step 2806, the operating system's process list is scanned to identify any running processes that match a service 230 that the core 228 is configured to run. In some embodiments, a service 230 may include a unique instance identifier as part of the service name, in which case the scanning of step 2806 may ignore services of the same basic name that do not match the correct instance. This allows multiple instances of the same NIO platform 402 to be run without creating identical process names in the operating system's process list. It is understood that identical services 230 from different instances may be differentiated in other ways. Furthermore, the method 2800 may account for cases in which such identically named services are not easily distinguished within the process list as will be described in a later step.

In step 2808, a determination is made as to whether there are any running processes in the operating system's process list that match a service 230 that this NIO platform 402 is configured to run. If no processes are found as determined in step 2808, the method 2800 moves to step 2812. If one or more processes are found, the method 2800 moves to step 2810. In step 2810, a determination is made as to whether it is possible to communicate with the service(s). For example, the determination of step 2810 may identify whether any communication information is available for a listed service process, either within the NIO platform instance 402 or elsewhere (e.g., maintained by the operating system 122). If it is not possible to communicate with the service (e.g., no communication information is available), the method 2800 moves to step 2812. In some embodiments, the method 2800 may terminate the service process prior to moving to step 2812.

If it is possible to communicate with the service 230 as determined in step 2810, the method 2800 moves to step 2814. In step 2814, an attempt is made to contact the service 230. In step 2816, a determination is made as to whether there has been a response from the service 230 (e.g., whether the attempt of step 2814 was successful). If there has not been a response, the method 2800 moves to step 2824, where a determination is made as to whether another service 230 is to be checked. If another service 230 is to be checked, the method 2800 returns to step 2814. If no other service 230 is to be checked, the method 2800 continues to step 2812.

If there has been a response as determined in step 2816, the method 2800 moves to step 2818. In step 2818, a determination is made as to whether the service 230 corresponds to the current NIO platform instance 402. In other words, step 2818 determines whether the service 230 belonged to this instance before the instance was restarted. For example, step 2818 may involve communicating with the service 230 to determine if the service 230 is currently communicating with another core 228. If the service 230 is communicating with another core 228, then the service 230 does not belong to the core process 228 that is executing the method 2800. Accordingly, if the determination of step 2818 indicates that the service 230 does not belong to the current NIO platform instance 402, the method 2800 continues to step 2824. If the service 230 does belong to the current NIO platform instance 402, the method 2800 moves to step 2820. In some embodiments, such as when the process name identifies a particular instance, step 2818 may not be performed.

In step 2820, the service 230 may be updated if needed. This may include generating updated information (e.g., a new SIC) and sending the information to the service 230. In step 2822, the service 230 is marked as running. The method 2800 then continues to step 2824.

Referring to FIG. 28B, a method 2850 illustrates another embodiment of FIG. 28A. In the present embodiment, the functionality provided by the method 2850 is illustrated as being applied on a per service basis during startup. Accordingly, step 2812 may be used to move the startup process to the startup step for the next service (which may include returning to step 2806) or to another step in the startup process. For example, for each service 230, the method 2850 would be executed, and may be executed in parallel for different services 230. In such an embodiment, steps 2806 and/or 2808 may be modified to prevent a running service 230 that has been recently started or reacquired from being processed using the method 2850. As the steps are numbered with the same reference numerals as are used in FIG. 28A and have the same functionality as previously described, the steps are not described in detail in the present embodiment.

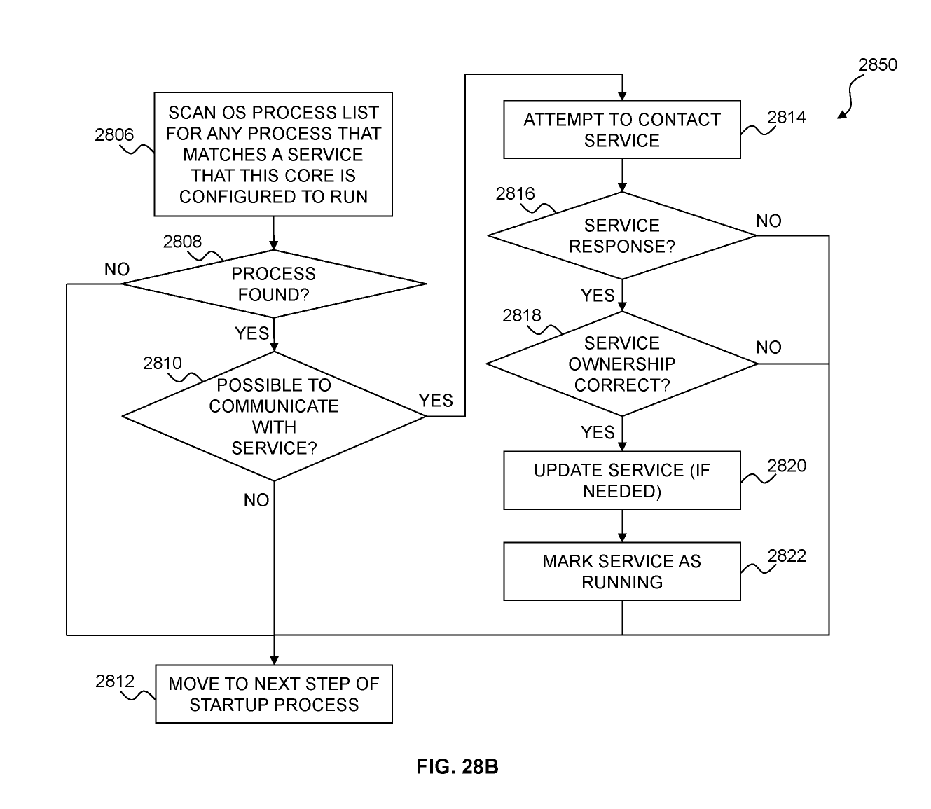

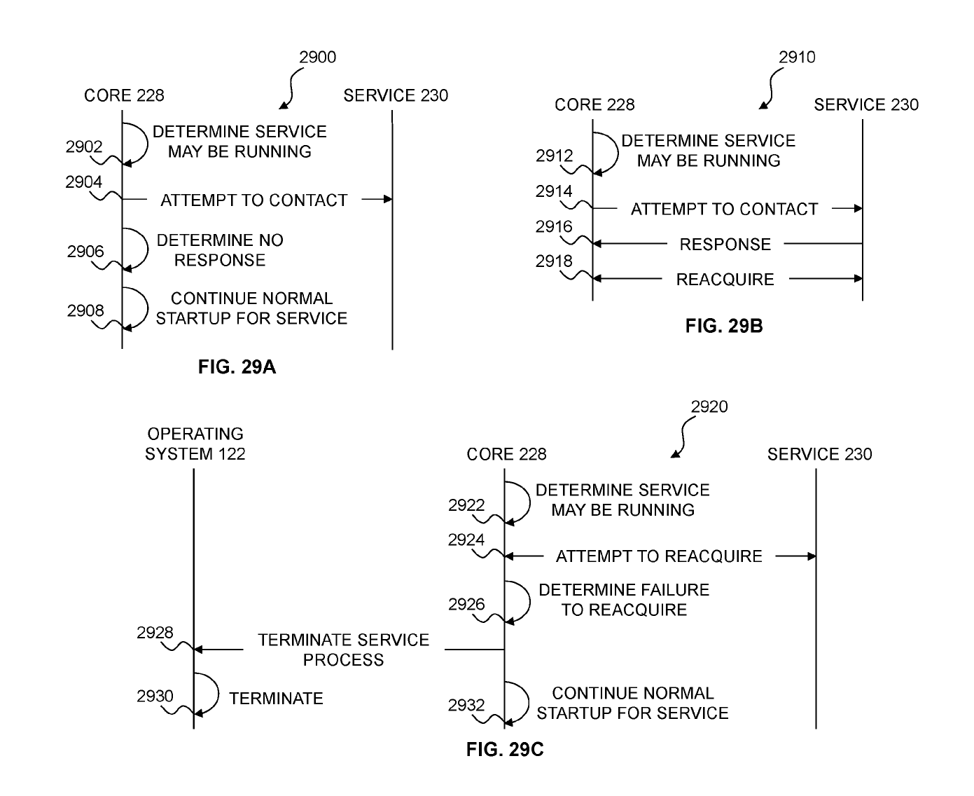

Referring to FIG. 29A, a sequence diagram 2900 illustrates one embodiment of a process that may be used when a NIO platform (e.g., the NIO platform 402 of FIG. 4) is started. In step 2902, a core 228 determines that a service 230 may already be running. In step 2904, the core 228 attempts to contact the service 230. In step 2906, the core 228 determines that there has been no response within a defined period of time. In step 2908, the core 228 continues the normal startup process for the service 230.

Referring to FIG. 29B, a sequence diagram 2910 illustrates one embodiment of a process that may be used when a NIO platform (e.g., the NIO platform 402 of FIG. 4) is started. In step 2912, a core 228 determines that a service 230 may already be running. In step 2914, the core 228 attempts to contact the service 230. In step 2916, the core 228 receives a response from the service 230. In step 2918, the core 228 reacquires the service 230, which may include updating the service 230.

Referring to FIG. 29C, a sequence diagram 2920 illustrates one embodiment of a process that may be used when a NIO platform (e.g., the NIO platform 402 of FIG. 4) is started. In step 2922, a core 228 determines that a service 230 may already be running. In step 2924, the core 228 attempts to reacquire the service 230, which may include attempting to contact the service 230 and waiting for a response. In step 2926, the core 228 determines that the attempt to reacquire the service 230 has failed. In step 2928, the core 228 sends an operating system 122 a request or an instruction to terminate the service process for the service 230. In step 2930, the operating system 122 terminates the service process. In step 2932, the core 228 continues the normal startup process for the service 230. It is understood that step 2932 may occur before, during, or after step 2930.

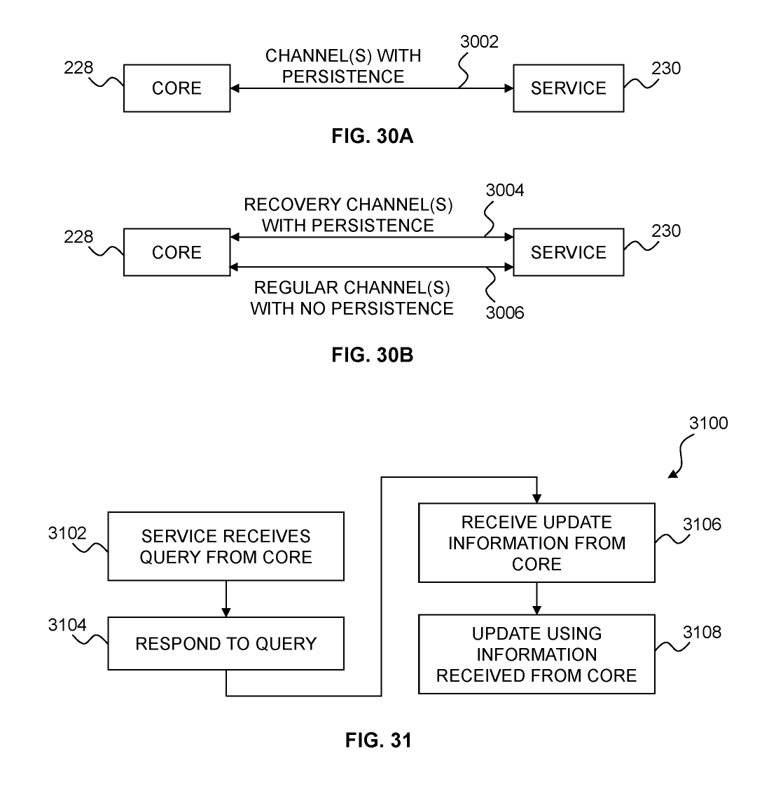

Referring to FIGS. 30A and 30B, embodiments are shown of different communication channel configurations. In FIG. 30A, one or more channels 3002 with persistence exist between a core 228 and a service 230. The channels 3002, which may be point to point, broadcast, publication/subscription, and/or any other type of appropriate channel model, are used for all communications between the core 228 and the service 230 and are capable of being used after the core 228 is restarted from a malfunctioning state.

In FIG. 30B, one or more recovery channels 3004 with persistence exist between a core 228 and a service 230. One or more regular channels 3006 without persistence also exist between the core 228 and the service 230. The recovery channels 3004, which may be point to point, broadcast, publication/subscription, and/or any other type of appropriate channel model, are used for recovery communications after the core 228 is restarted from a malfunctioning state. The regular channels 3006, which may be point to point, broadcast, publication/subscription, and/or any other type of appropriate channel model, are used for general communications.

Referring to FIG. 31, a method 3100 illustrates one embodiment of a process that may be executed by a service 230 within a NIO platform 402. In the present example, the core 228 has malfunctioned and been restarted, and the service 230 has continued to run during the restart process. In step 3102, the service 230 receives a query from the core 228. The query may be received via a regular channel or a recovery channel depending on the particular configuration of the NIO platform 402. In step 3104, the service 230 responds to the query. In step 3106, the service 230 receives update information from the core 228. In step 3108, the service 230 applies the update information. The service 230 may apply all update information or may apply the updates selectively.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

For example, in one embodiment, a method for execution by a configurable platform instance includes determining, by a core that is configured to start a plurality of services for a configurable platform instance that is running on a device, that a first service of the plurality of services is running on the device and that the first service corresponds to a previous instance of the configurable processing platform, wherein the determining occurs during a startup sequence of the configurable platform instance; and reacquiring, by the core, the first service in order to integrate the first service with the configurable platform instance, wherein a normal startup process for the first service is not performed by the core because the first service has been reacquired.

In some embodiments, the method further includes performing, by the core, a normal startup process for a second service of the plurality of services.

In some embodiments, reacquiring the first service includes communicating with the first service to determine that the first service is not currently associated with another instance of the configurable platform instance.

In some embodiments, communicating with the first service includes: identifying a persistent channel that existed between the first service and the previous instance; and sending a message to the first service via the persistent channel.

In some embodiments, reacquiring the first service includes updating the first service.

In some embodiments, updating the first service includes: generating a service initialization context for the first service; and sending the session initialization context to the first service.

In some embodiments, the method further includes determining, by the core, that the previous instance was not properly shut down prior to determining that the first service is running.

In some embodiments, the method further includes determining that a second service of the plurality of services is running on the device and that the second service corresponds to the previous instance; attempting to reacquire the second service; determining that the second service cannot be reacquired; and performing a normal startup process to create a new instance of the second service.

In some embodiments, the method further includes terminating the second service before performing the normal startup process to create the new instance of the second service.

In some embodiments, terminating the second service includes sending a message to an operating system on the device to terminate a process corresponding to the second service.

In some embodiments, determining that the first service is running on the device includes: identifying a persistent channel that existed between the first service and the previous instance; sending a message to the first service via the persistent channel; and receiving a response to the message from the first service.

In some embodiments, determining that the first service is running on the device includes: scanning a process list of running processes maintained by an operating system of the device; and identifying a process corresponding to the first service on the process list.

In another embodiment, a method for execution by a configurable platform instance includes determining, by a core that is configured to start a plurality of services for a configurable platform instance that is running on a device, that a first service of the plurality of services is running on the device and that the first service corresponds to a previous instance of the configurable processing platform, wherein the determining occurs during a startup sequence of the configurable platform instance; performing, by the core, an attempt to reacquire the first service in order to integrate the first service with the configurable platform instance; determining, by the core, that the attempt to reacquire the first service was unsuccessful; and starting, by the core, a new instance of the first service using a normal startup process for the first service.

In some embodiments, the method further includes terminating the first service starting the new instance of the first service.

In some embodiments, terminating the first service includes sending a message to an operating system on the device to terminate a process corresponding to the first service.

In some embodiments, performing the attempt to reacquire the first service includes sending a message to the first service via persistent channel that existed between the first service and the previous instance.

In some embodiments, determining that the attempt to reacquire the first service was unsuccessful includes determining that no response to the message has been received from the first service.

In some embodiments, wherein determining that the first service is running on the device includes: identifying a persistent channel that existed between the first service and the previous instance; sending a message to the first service via the persistent channel; and receiving a response to the message from the first service.

In some embodiments, determining that the first service is running on the device includes: scanning a process list of running processes maintained by an operating system of the device; and identifying a process corresponding to the first service on the process list.

In another embodiment, a method for execution by a configurable platform instance includes determining, by a core of a configurable platform instance that is running on a device, whether any of a plurality of services that the core is configured to start are currently running on the device before being started by the core, wherein the determining occurs during a startup sequence of the configurable platform instance; attempting, by the core, to reacquire any of the plurality of services that are currently running, wherein reacquiring a service integrates the service with the configurable platform instance, and wherein a normal startup process is not performed for any service that has been reacquired; and performing, by the core, the normal startup process to create a new instance of any of the plurality of services that have not been reacquired and are to be started.

In another embodiment, a configurable platform includes a core configured to interact with an operating system on a device; and at least a first service that is configured to be run by the core, wherein the core is configured to determine whether the first service is running before starting the first service using a normal startup process, wherein the core is configured to attempt to reacquire the first service if the first service is running, and wherein the core is configured to perform a normal startup process for the first service if the first service is not running or if the first service is running and cannot be reacquired.

In another embodiment, a system includes a processor; and a memory coupled to the processor and containing instructions for execution by the processor, the instructions for providing a configurable platform instance that is configured to interact with an operating system and run any of a plurality of services defined for the configurable platform instance; determining, by a core that is configured to start the plurality of services for the configurable platform instance, that a first service of the plurality of services is running on the system and that the first service corresponds to a previous instance of the configurable processing platform, wherein the determining occurs during a startup sequence of the configurable platform instance; and reacquiring, by the core, the first service in order to integrate the first service with the configurable platform instance, wherein a normal startup process for the first service is not performed by the core because the first service has been reacquired.

In some embodiments, the instructions further include instructions for performing, by the core, a normal startup process for a second service of the plurality of services.

In some embodiments, reacquiring the first service includes communicating with the first service to determine that the first service is not currently associated with another instance of the configurable platform instance.

In some embodiments, communicating with the first service includes: identifying a persistent channel that existed between the first service and the previous instance; and sending a message to the first service via the persistent channel.

In some embodiments, reacquiring the first service includes updating the first service.

In some embodiments, updating the first service includes: generating a service initialization context for the first service; and sending the session initialization context to the first service.

In some embodiments, the instructions further include instructions for determining, by the core, that the previous instance was not properly shut down prior to determining that the first service is running.

In some embodiments, the instructions further include instructions for: determining that a second service of the plurality of services is running on the system and that the second service corresponds to the previous instance; attempting to reacquire the second service; determining that the second service cannot be reacquired; and performing a normal startup process to create a new instance of the second service.

In some embodiments, the instructions further include instructions for terminating the second service before performing the normal startup process to create the new instance of the second service.

In some embodiments, terminating the second service includes sending a message to the operating system to terminate a process corresponding to the second service.

In some embodiments, determining that the first service is running on the system includes: identifying a persistent channel that existed between the first service and the previous instance; sending a message to the first service via the persistent channel; and receiving a response to the message from the first service.

In some embodiments, determining that the first service is running on the system includes: scanning a process list of running processes maintained by the operating system; and identifying a process corresponding to the first service on the process list.

In another embodiment, a system includes a processor; and a memory coupled to the processor and containing instructions for execution by the processor, the instructions for providing a configurable platform instance that is configured to interact with an operating system and run any of a plurality of services defined for the configurable platform instance; determining, by a core that is configured to start the plurality of services for the configurable platform instance, that a first service of the plurality of services is running on the system and that the first service corresponds to a previous instance of the configurable processing platform, wherein the determining occurs during a startup sequence of the configurable platform instance; performing, by the core, an attempt to reacquire the first service in order to integrate the first service with the configurable platform instance; determining, by the core, that the attempt to reacquire the first service was unsuccessful; and starting, by the core, a new instance of the first service using a normal startup process for the first service.

In some embodiments, the instructions further include instructions for terminating the first service starting the new instance of the first service.

In some embodiments, terminating the first service includes sending a message to the operating system to terminate a process corresponding to the first service.

In some embodiments, performing the attempt to reacquire the first service includes sending a message to the first service via persistent channel that existed between the first service and the previous instance.

In some embodiments, determining that the attempt to reacquire the first service was unsuccessful includes determining that no response to the message has been received from the first service.

In some embodiments, determining that the first service is running on the system includes: identifying a persistent channel that existed between the first service and the previous instance; sending a message to the first service via the persistent channel; and receiving a response to the message from the first service.

In some embodiments, determining that the first service is running on the system includes: scanning a process list of running processes maintained by the operating system; and identifying a process corresponding to the first service on the process list.

In another embodiment, a system includes a processor; and a memory coupled to the processor and containing instructions for execution by the processor, the instructions for providing a configurable platform instance that is configured to interact with an operating system and run any of a plurality of services defined for the configurable platform instance; determining, by a core of the configurable platform instance, whether any of a plurality of services that the core is configured to start are currently running on the device before being started by the core, wherein the determining occurs during a startup sequence of the configurable platform instance; attempting, by the core, to reacquire any of the plurality of services that are currently running, wherein reacquiring a service integrates the service with the configurable platform instance, and wherein a normal startup process is not performed for any service that has been reacquired; and performing, by the core, the normal startup process to create a new instance of any of the plurality of services that have not been reacquired and are to be started.

What is claimed is:

1. A method for execution by a configurable platform instance, the method comprising:
determining, by a core that is configured to start a plurality of services for a configurable platform instance that is running on a device, that a first service of the plurality of services is running on the device and that the first service corresponds to a previous instance of the configurable processing platform, wherein the determining occurs during a startup sequence of the configurable platform instance; and
reacquiring, by the core, the first service in order to integrate the first service with the configurable platform instance, wherein a normal startup process for the first service is not performed by the core because the first service has been reacquired.

2. The method of claim 1 further comprising performing, by the core, a normal startup process for a second service of the plurality of services.

3. The method of any one of claim 1 or 2 wherein reacquiring the first service includes communicating with the first service to determine that the first service is not currently associated with another instance of the configurable platform instance.

4. The method of claim 3 wherein communicating with the first service includes:
identifying a persistent channel that existed between the first service and the previous instance; and
sending a message to the first service via the persistent channel.

5. The method of any one of claims 1 through 4 wherein reacquiring the first service includes updating the first service.

6. The method of claim 5 wherein updating the first service includes:
generating a service initialization context for the first service; and
sending the session initialization context to the first service.

7. The method of any one of claims 1 through 6 further comprising determining, by the core, that the previous instance was not properly shut down prior to determining that the first service is running.

8. The method of any one of claim 1 or 3 through 7 further comprising:
determining that a second service of the plurality of services is running on the device and that the second service corresponds to the previous instance;
attempting to reacquire the second service;
determining that the second service cannot be reacquired; and
performing a normal startup process to create a new instance of the second service.

9. The method of claim 8 further comprising terminating the second service before performing the normal startup process to create the new instance of the second service.

10. The method of claim 9 wherein terminating the second service includes sending a message to an operating system on the device to terminate a process corresponding to the second service.

11. The method of any one of claims 1 through 10 wherein determining that the first service is running on the device includes:
identifying a persistent channel that existed between the first service and the previous instance;
sending a message to the first service via the persistent channel; and
receiving a response to the message from the first service.

12. The method of any one of claims 1 through 10 wherein determining that the first service is running on the device includes:
scanning a process list of running processes maintained by an operating system of the device; and
identifying a process corresponding to the first service on the process list.

13. A configurable platform comprising:
a core configured to interact with an operating system on a device; and
at least a first service that is configured to be run by the core, wherein the core is configured to determine whether the first service is running before starting the first service using a normal startup process, wherein the core is configured to attempt to reacquire the first service if the first service is running, and wherein the core is configured to perform a normal startup process for the first service if the first service is not running or if the first service is running and cannot be reacquired.

14. A system comprising:
a processor; and
a memory coupled to the processor and containing instructions for execution by the processor, the instructions for:
providing a configurable platform instance that is configured to interact with an operating system and run any of a plurality of services defined for the configurable platform instance;
determining, by a core that is configured to start the plurality of services for the configurable platform instance, that a first service of the plurality of services is running on the system and that the first service corresponds to a previous instance of the configurable processing platform, wherein the determining occurs during a startup sequence of the configurable platform instance; and
reacquiring, by the core, the first service in order to integrate the first service with the configurable platform instance, wherein a normal startup process for the first service is not performed by the core because the first service has been reacquired.

15. The system of claim 14 wherein the instructions further include instructions for performing, by the core, a normal startup process for a second service of the plurality of services.

16. The system of any one of claim 14 or 15 wherein reacquiring the first service includes communicating with the first service to determine that the first service is not currently associated with another instance of the configurable platform instance.

17. The system of claim 16 wherein communicating with the first service includes:
identifying a persistent channel that existed between the first service and the previous instance; and
sending a message to the first service via the persistent channel.

18. The system of any one of claims 14 through 17 wherein reacquiring the first service includes updating the first service.

19. The system of claim 18 wherein updating the first service includes:
generating a service initialization context for the first service; and
sending the session initialization context to the first service.

20. The system of any one of claims 14 through 19 wherein the instructions further include instructions for determining, by the core, that the previous instance was not properly shut down prior to determining that the first service is running.

21. The system of any one of claim 14 or 16 through 20 wherein the instructions further include instructions for:
determining that a second service of the plurality of services is running on the system and that the second service corresponds to the previous instance;
attempting to reacquire the second service;
determining that the second service cannot be reacquired; and
performing a normal startup process to create a new instance of the second service.

22. The system of claim 21 wherein the instructions further include instructions for terminating the second service before performing the normal startup process to create the new instance of the second service.

23. The system of claim 22 wherein terminating the second service includes sending a message to the operating system to terminate a process corresponding to the second service.

24. The system of any one of claims 14 through 23 wherein determining that the first service is running on the system includes:
identifying a persistent channel that existed between the first service and the previous instance;
sending a message to the first service via the persistent channel; and
receiving a response to the message from the first service.

25. The system of any one of claims 14 through 23 wherein determining that the first service is running on the system includes:
scanning a process list of running processes maintained by the operating system; and
identifying a process corresponding to the first service on the process list.
